(19) United States
(12) Patent Application Publication
(10) Pub. No.: US 2026/0308028 A1
(43) Pub. Date: Oct. 8, 2026

(54) SYSTEMS AND METHODS FOR REMOVING AQUEOUS DISINFECTANTS USING ZERO-VALENT IRON MEDIA

(71) Applicant: Pentair, Inc., Golden Valley, MN (US)

(72) Inventors: Sarah Nichole Dawson, White Bear Lake, MN (US); James Fell, Glendale Heights, IL (US)

(21) Appl. No.: 19/634,831

(22) Filed: Mar. 31, 2026

Related U.S. Application Data
(60) Provisional application No. 63/783,438, filed on Apr. 4, 2025.

(51) Int. Cl. C02F 1/76

(52) U.S. Cl. CPC C02F 1/76; C02F 2209/29; C02F 2303/185

(57) ABSTRACT

A water treatment system is provided. The water treatment system includes a treatment tank including an inlet in fluid communication with a source of untreated water, where the untreated water is imparted with a first concentration of an aqueous substance, an outlet designed to provide a treated water from the treatment tank, where the treated water is imparted with a second concentration of the aqueous substance, and a particle bed including zero-valent iron media disposed within the treatment tank, the particle bed designed to produce the treated water from the untreated water.

### CROSS-REFERENCE TO RELATED APPLICATIONS

This application claims priority from U.S. Patent Application No. 63/783,438, titled “SYSTEMS AND METHODS FOR REMOVING AQUEOUS DISINFECTANTS USING ZERO-VALENT IRON MEDIA,” filed on Apr. 4, 2025, the entirety of which is incorporated herein by reference.

### FIELD OF DISCLOSURE

The present disclosure relates to systems and methods for removing aqueous substances from a water supply using zero-valent iron media. More particularly, the present disclosure relates to systems and methods for removing oxidizing disinfectants, such as chloramine, from a water supply using a bed of zero-valent iron particles.

### BACKGROUND

Chloramine is increasingly used as a disinfectant in public water supplies since chloramine is a more stable alternative to chlorine. Chloramine, which, as a class of molecules, includes mono-, di-, and trichloramines, is formed by the reaction between ammonia and chlorine. While di-and trichloramines are unstable and spontaneously dissipate rapidly, monochloramine is a relatively strong oxidizer that remains stable in water for days at ambient temperatures and a pH above 7.2. Thus, the monochloramine form is used as a public water supply disinfectant.

Once a water supply is treated with chloramine, the chloramine is often removed prior to use of the water, e.g., for drinking, washing, irrigation, etc. However, this removal process may be complicated by chloramine's high stability. In addition, conventional means for purifying water, such as activated carbon, may have reduced effectiveness in removing chloramine. Additionally, consumers may object to even small amounts of chloramine in point-of-use water due to aqueous chloramine's strong bleach and “fishy” aroma.

A specialized family of activated carbons known as “catalytic” activated carbons has been developed to enhance their chloramine reduction capacity, but the performance of these catalytic carbons in terms of rate and capacity is still inferior to that which is possible for conventional chlorine reduction. Products using single-use catalytic activated carbon beds for chloramine reduction may be quickly exhausted and require frequent replacement with fresh beds, leading to considerable expense and material waste.

Thus, there is a need for improved systems and methods for removing chloramine and other such oxidizing disinfectants from water sources that are non-toxic, inexpensive, effective, and regenerable.

### SUMMARY

In a first aspect, a water treatment system is provided. The water treatment system includes a treatment tank including an inlet in fluid communication with a source of untreated water, where the untreated water is imparted with a first concentration of an aqueous substance, an outlet designed to provide a treated water from the treatment tank, where the treated water is imparted with a second concentration of the aqueous substance, and a particle bed including zero-valent iron media disposed within the treatment tank, the particle bed designed to produce the treated water from the untreated water.

In some instances, the aqueous substance is an oxidizing disinfectant compound.

In other instances, the oxidizing disinfectant compound is selected from the group consisting of ozone, chlorine, chloramine, chlorine dioxide, and combinations thereof.

In yet further instances, the aqueous substance is a non-oxidizing disinfectant compound.

In some instances, the aqueous substance is selected from the group consisting of oxidizing disinfectant compounds, non-oxidizing disinfectant compounds, heavy metals, volatile organic compounds, and combinations thereof.

In other instances, the particle bed consists essentially of zero-valent iron particles.

In yet further instances, the particle bed includes a substrate, and a surface of the substrate is coated with zero-valent iron particles.

In another aspect, a water treatment system is provided. The water treatment system includes a housing, an inlet and an outlet that are in fluid communication with an interior of the housing, and a zero-valent iron media bed positioned within the interior of the housing. The zero-valent iron media bed is designed to remove a disinfectant compound from an untreated water provided to the inlet.

In some instances, the water treatment system further includes a first sensor in fluid communication with the outlet and a controller in electrical communication with the first sensor. The untreated water is imparted with a first concentration of chloramine. The first sensor is designed to measure a second concentration of chloramine in a treated water produced by the water treatment system and provide a measured value of the second concentration to the controller.

In other instances, the water treatment system further includes a second sensor in fluid communication with the inlet and in electrical communication with the controller, where the second sensor is designed to measure the first concentration of chloramine in the untreated water and provide a measured value of the first concentration to the controller.

In yet further instances, the water treatment system further includes a flow meter in fluid communication with the housing and in electrical communication with the controller. The first sensor measures the second concentration of chloramine at regular intervals, where the regular intervals are based on a volume of water measured by the flow meter.

In some instances, the housing further includes a top portion, a bottom portion, and a surface provided in the form of a mesh that extends from the top portion to the bottom portion. The top portion, the bottom portion, and the surface together define the interior of the housing. The mesh includes a plurality of orifices imparted with a first diameter. The iron media bed includes a plurality of iron particles imparted with a second diameter. The first diameter is smaller than the second diameter.

In other instances, the zero-valent iron media bed produces a treated water from the untreated water. The untreated water is imparted with a first concentration of chloramine and the treated water is imparted with a second concentration of chloramine. The second concentration of chloramine is at least about 90% less than the first concentration of chloramine.

In yet further instances, the zero-valent iron media bed produces a treated water from the untreated water and the treated water is imparted with a chloramine concentration of no more than about 4 ppm.

In yet another aspect, a method for reducing a concentration of a disinfectant in a water stream is provided. The method includes providing a zero-valent iron media bed in a water treatment system and passing the untreated water through the zero-valent iron media bed to remove the disinfectant from the untreated water, thereby producing a treated water.

In some instances, the method further includes providing a first sensor in fluid communication with a source of untreated water, providing a second sensor in fluid communication with a source of the treated water, measuring a first concentration of the aqueous disinfectant in the untreated water, measuring a second concentration of the aqueous disinfectant in the treated water, and determining a media bed saturation status. The media bed saturation status is a differential between the first concentration of the aqueous disinfectant and the second concentration of the aqueous disinfectant.

In other instances, the second concentration is at least about 95% less than the first concentration when the zero-valent iron media bed is unsaturated.

In yet further instances, the method further includes washing the zero-valent iron media with a reducing solution and reducing the saturation of the zero-valent iron media bed.

In some instances, the first sensor and the second sensor are in electrical communication with a controller and the controller determines a differential between the first concentration and the second concentration and compares the differential with a predetermined threshold value.

### DESCRIPTION OF THE DRAWINGS

FIG. 1 is a schematic representation of a home water system including a disinfectant removal system;

FIG. 2 is a schematic representation of a water treatment system including a disinfectant removal system;

FIG. 3 is a schematic representation of a disinfectant removal system including an iron media bed;

FIG. 4 is a schematic representation of a disinfectant removal system tank including an iron media bed;

FIG. 5 is a schematic representation of another disinfectant removal system tank including an iron media bed;

FIG. 6 is a front isometric view of an exemplary retaining apparatus for an iron media;

FIG. 7A is a schematic representation of a cross-section of a first configuration of an iron media bed;

FIG. 7B is a schematic representation of a cross-section of a particle of the iron media bed of FIG. 7A;

FIG. 8A is a schematic representation of a cross-section of a second configuration of an iron media bed;

FIG. 8B is a schematic representation of a cross-section of a particle of the iron media bed of FIG. 8A;

FIG. 9A depicts an SEM image of a granular activated carbon substrate;

FIG. 9B depicts an SEM image of an iron-coated granular activated carbon substrate;

FIG. 10A illustrates a graph depicting pressure drop through a zero-valent iron media bed versus a volume of water during a first trial;

FIG. 10B illustrates a graph depicting a chemistry of effluent water passing through an iron media bed versus a volume of water during a first trial;

FIG. 11 illustrates a graph depicting a chemistry of effluent water passing through an iron media bed versus a volume of water during a second trial; and

FIG. 12 illustrates a flow diagram depicting a method of using a disinfectant removal system for treatment of sanitized water.

### DETAILED DESCRIPTION

Before any aspects of the disclosure are explained in detail, it is to be understood that the disclosure is not limited in its application to the details of construction and the arrangement of components set forth in the following description or illustrated in the following drawings. The disclosure is capable of other aspects and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, the terms “reduced” and “reduction” refer to chemical reactions including an electron donation step, wherein electrons are transferred from an electron-rich or nucleophilic source to an electron-deficient or electrophilic source. In various instances, the reduction of a compound by way of electron transfer is one in a series of steps that lead to the destruction of the compound, creating one or more byproducts.

The following discussion is presented to enable a person skilled in the art to make and use aspects of the disclosure. Various modifications to the illustrated aspects will be readily apparent to those skilled in the art, and the generic principles herein may be applied to other aspects and applications without departing from aspects of the disclosure. Thus, aspects of the disclosure are not intended to be limited to aspects shown but are to be accorded the widest scope consistent with the principles and features disclosed herein. The figures, which are not necessarily to scale, depict selected aspects and are not intended to limit the scope of aspects of the disclosure. Skilled artisans will recognize that the examples provided herein have many useful alternatives and fall within the scope of aspects of the disclosure.

According to the teachings herein, a water treatment system and methods of using the water treatment system are provided. The water treatment system may be provided in the form of a disinfectant removal system including an iron media bed. The iron media bed may remove disinfectant compounds provided in the form of aqueous compounds such as chloramine and, optionally, other oxidizers from water provided to a treatment tank via an inlet conduit. The treated water produced by the treatment tank may then be provided to an outlet conduit and ultimately to an end user. Thus, the water treatment system may be designed to remove chloramine, chlorine, ozone, chlorine dioxide, and other disinfecting agents from various sources of water. In particular instances, the water treatment system may be designed to remove chloramine from a water stream. In some instances, the iron media bed may comprise, consist essentially of, or consist of zero-valent iron particles. In some such instances, the iron media bed may include a magnet designed to prevent particles of the iron media bed from exiting a retaining apparatus in which the iron media bed may be disposed. In certain instances, the iron media bed may be configured to process water in an upflow configuration, although the iron media bed may also be configured to process water in a downflow configuration.

In certain instances, the iron media bed may also remove non-oxidizing disinfectant substances from water, such as alcohols, quaternary ammonia compounds, and the like.

In some instances, the iron media bed may further remove aqueous contaminants from water, such as volatile organic compounds (“VOCs”), heavy metals, and/or disinfectant byproducts such as chloronitramide ion.

In some cases, the iron media bed may remove one or more aqueous substances from water, the aqueous substances including any of the disinfecting agents, oxidizing disinfectants, non-oxidizing disinfectants, and other aqueous contaminants (e.g., VOCs, heavy metals, disinfectant byproducts) described herein.

The iron media bed may be provided as a rigid, non-compressible media. The iron media bed may be configured to have a low pressure drop when implemented and a long contact time with untreated water, thereby facilitating high throughput and substantially complete or complete chloramine destruction.

In addition, the system may include one or more sensors designed to monitor the concentrations of the oxidizing compounds over time. The one or more sensors may be provided in the form of amperometric sensors or electrodes that may be in fluid communication with an inlet and/or outlet conduit of the treatment tank. Alternatively, the one or more sensors may take the form of automated kits or monitors that may be in fluid communication with an inlet and/or outlet conduit of the treatment tank. The one or more sensors may be used to determine a concentration of disinfectants in the treated water, which in turn may help determine whether the iron media bed requires regeneration. In various instances, only a single sensor may be provided in the disinfectant removal system.

The amperometric sensors may be provided as electroanalytical sensors whose signals may be directly proportional to the concentration of a substance in a solution. Amperometric sensors typically include a gas-permeable membrane behind which an electrochemical cell may be located. The substance may undergo an oxidation-reduction reaction within the cell, and the resulting electrical current from the oxidation-reduction reaction may be measured to determine the concentration of an aqueous substance. Thus, the quantitative output value of an amperometric sensor may be provided in units of either concentration or current. In some instances, the amperometric sensor may provide data to a controller associated with the disinfectant removal system, and the controller, using the data, may determine when the iron media bed requires regeneration.

Automated kits may include components including, but not limited to, colorimeters, photometric analyzers, test strips, and testing samples. In an automated kit, the aqueous substance may be mixed with the testing sample to produce a solution whose color saturation may be measured by the photometric analyzer(s) and/or colorimeter(s). Thus, the quantitative output value of such a kit may be provided in units of concentration, absorbance, or transmittance. In some instances, the automated kits may provide data to a controller associated with the water treatment system, and the controller, using the data, may determine when the iron media bed requires regeneration.

The above testing systems may measure, detect, or determine a concentration of the disinfectants in the untreated and/or treated water at regular or predetermined intervals defined by an amount or volume of water flowing through the water treatment system. The controller may then alert a user as to the efficacy of the treatment system (e.g., as determined by an amount of aqueous disinfectants removed from the untreated water) or whether regeneration of the iron media bed may be imminent, in which case the controller may direct the system to initiate regeneration of the iron media bed. In some instances, the system described herein may include one sensor within the disinfectant removal system, located at, for example, an outlet of the disinfectant removal system. In other instances, the system described herein may include two or more sensors located at, for example, an inlet and an outlet of the disinfectant removal system to determine efficacy and the need for regeneration of the iron media bed within the disinfectant removal system. The controller may use the information obtained from the at least one sensor (e.g., a concentration differential determined from the disinfectants' concentrations at the inlet and the outlet) to determine whether regeneration may be necessary. In some cases, the controller may compare the concentrations or the concentration differential to predetermined threshold values to determine whether regeneration may be necessary. For example, if at least one of the concentrations and the concentration differential may be above the threshold value, the controller may determine that regeneration may be needed. In some such cases, the controller may produce an alert if the concentration differential may be near but not at the threshold value.

It is to be understood that the concentration of disinfectants in a water stream may refer to a concentration of a single disinfectant in the water stream, or a sum of the individual concentrations of one or more disinfectants in the water stream.

In some instances, the water treatment system may comprise a disinfectant removal system including an iron media bed. In some instances, the iron media bed comprises, consists essentially of, or consists of zero-valent iron particles, i.e., iron with an oxidation state of zero. As a strong reducing agent, zero-valent iron may readily donate electrons to oxidizers, such as disinfectants added to water for sanitization, thereby leading to chemical modification or destruction of the oxidizers. In addition, as the iron media may be imparted with a high surface area-to-volume ratio, the iron media bed may effectively remove disinfectants or contaminants from the water. Further, the iron media bed may undergo a regeneration process to flush away unwanted adsorbed byproducts that reduce the efficacy of the iron media bed.

The water treatment system including the iron media bed may be used in various applications, including, by way of example, residential use, commercial use, municipal water treatment, and industrial water processing. By way of further example, the system may be installed in a private residence for potable water treatment, in a commercial building for process water purification, in a municipal facility for public water supply treatment, or in an industrial plant for wastewater remediation. In certain instances, the water treatment system including the iron media bed may be designed to provide water for use in residential or industrial settings (e.g., for drinking, creating beverages, cooking, etc.).

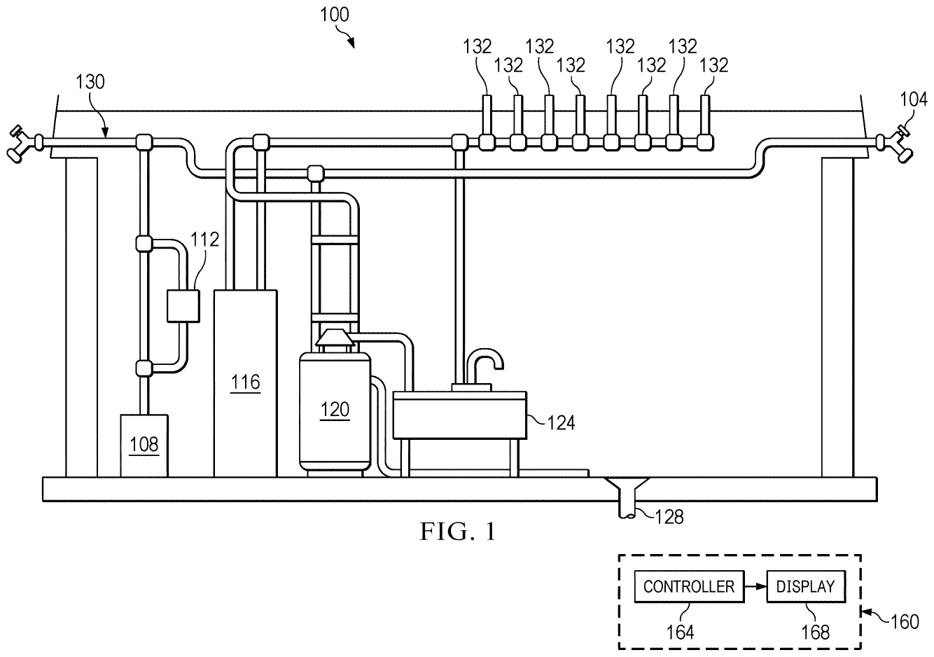

Referring now to FIG. 1, a home water system 100 may be provided in the form of a faucet 104, a pump 108, a disinfectant removal system 112, a water heater 116, a water softener system 120, a laundry system 124, a drain 128, one or more conduits 130, and outlets 132. The aforementioned components of the home water system 100 may be placed in fluid communication via the one or more conduits 130. The home water system 100 and the water softener system 120 may be similar to the systems described in U.S. patent application Ser. No. 19/002,269, titled “System and Methods for Resin Breakthrough Identification Using Ion-Selective Electrodes,” the disclosure of which is incorporated by reference in its entirety herein. The home water system 100 may be designed to supply water to various home appliances on demand.

In addition, the home water system 100 may be designed to supply treated and/or softened water to a user when the home water system 100 is provided with the disinfectant removal system 112. The treated water may be at least partially, substantially, or completely free of one or more disinfectant compounds (e.g., chloramine). As shown in FIG. 1, untreated water including disinfectants, contaminants, or other aqueous substances may be supplied from the pump 108 to the home water system 100. The untreated water may either circulate through the home water system 100 and exit through the faucet 104 without treatment or be provided to the disinfectant removal system 112. For example, a valve may be actuated to a closed position to prevent water from being provided to the disinfectant removal system 112, while the valve may be actuated to an open position to allow for water to be provided to the disinfectant removal system 112. It is to be appreciated that other methods and means of allowing and/or preventing water flow to the disinfectant removal system 112 may be used than those described herein. Further, the disinfectant removal system 112 may be positioned “in-line” or “on-line” with respect to any of the conduits of the one or more conduits 130 without departing from the spirit of the disclosure.

The disinfectant removal system 112 may be designed to remove unwanted aqueous oxidizing agents, such as disinfectants previously added for sanitization, and/or other substances from the untreated water. The disinfectant removal system 112 may contain one or more filtration media, such as activated carbon, a resin bed, or an iron media bed, to remove the aqueous disinfectants. In some instances, the disinfectant removal system 112 includes a zero-valent iron media bed comprised of zero-valent iron particles, which may destroy and remove the aqueous disinfectants and/or other substances via electron donation. In some instances, the zero-valent iron media bed may be provided as a rigid, non-compressible media. In addition, the zero-valent iron media bed may be configured to have a low pressure drop and a long contact time with untreated water when implemented. Thus, the zero-valent iron media bed may facilitate high throughput of the untreated water and substantially complete or complete disinfectant destruction (e.g., chloramine destruction).

After treatment, treated water may be provided to the water softener system 120. The water softener system 120 may be designed to remove hardness-imparting ions—such as divalent and/or trivalent ions (e.g., calcium ions and magnesium ions)—from the water via filtration through a resin bed. The resin bed may be comprised of, consist essentially of, or consist of beads that provide a surface to which the divalent and trivalent ions in the hard water may bond, thereby replacing the divalent and trivalent ions with monovalent ions (e.g., sodium and potassium) and generating a softened water. The treated, softened water may exit the water softener system 120 and be provided through the outlets 132 to home appliances such as the laundry system 124, a bathtub, a toilet, a kitchen sink, and other appliances.

The home water system 100 may further include a control system 160 provided in the form of a central controller 164 and a display 168. The control system 160 may include a processor, a memory, an input/output device, and a power supply (not depicted). The display 168 may interface with the central controller 164 either over a local area network or via a cloud network. The central controller 164 may be a gateway, a hub, a switch, a router, a server, or another connection device to allow integration, monitoring, and control of multiple aspects of the home water system 100. The central controller 164 may be physically disposed on or within the home water system 100. In other instances, the central controller 164 may be located external to the home water system 100 and may be connected via Bluetooth, WiFi, internet, remote control, wired connection, and/or other similar communication technologies. The display 168 may be provided in the form of a screen (e.g., an LCD screen), a cell phone, a tablet, or any other similar electronic device designed to communicate information to a user. In some instances, the display 168 may include a camera and/or a user interface. The display 168 may include native, mobile, or web-based applications to facilitate user communication with the central controller 164.

In some instances, the central controller 164 may be designed to control the functions and output of one or more components of the home water system 100 by sending instructions to, collecting data from, or monitoring one or more components of the home water system 100 described herein. Additionally, the central controller 164 may communicate information to a user of the home water system 100, a servicer of the home water system 100, or a person or company by sending notifications, alerts, or information to the display 168.

The central controller 164 may receive electronic signals from one or more of the components of the home water system 100 described herein. One or more of the components of the home water system 100 may include one or more sensors that detect data and/or collect measurements regarding pressure, flow rate, total dissolved solids, conductivity, pH level, or the temperature of the water at various locations in the home water system 100. Electronic signals may be sent continuously, in real time, frequently, or periodically from the one or more sensors to provide data to the central controller 164. In some instances, the central controller 164 may instruct a change in one or more components of the home water system 100 in response to a reading from one or more of the one or more sensors. It is to be appreciated that the central controller 164 may instruct a change in any of the components of the home water system 100 more than once.

It should be noted that various communication methodologies and connections may be implemented to work in conjunction with, or independent from, one or more local controllers (not shown) associated with one or more individual components of the home water system 100 (e.g., a pump controller, a heater controller, the disinfectant removal system 112, etc.). For example, the central controller 164 and/or the local controllers may utilize a Local Area Network (LAN), a Wide Local Area Network (WLAN), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information.

Still referring to FIG. 1, the central controller 164 may implement machine learning (ML), artificial intelligence (AI), or similar processes to iteratively train the central controller 164 and improve performance of the various components of the home water system 100 based on one or more feedback parameters, characteristics, or similar information.

It is to be understood that while a home water system (i.e., the home water system 100) is shown in FIG. 1, the disinfectant removal system 112 may be used in any residential or commercial setting. For example, the disinfectant removal system 112 may be provided as part of the water system of an apartment complex, a restaurant, a coffee shop, a beverage and/or ice dispenser, a fitness center, or the like.

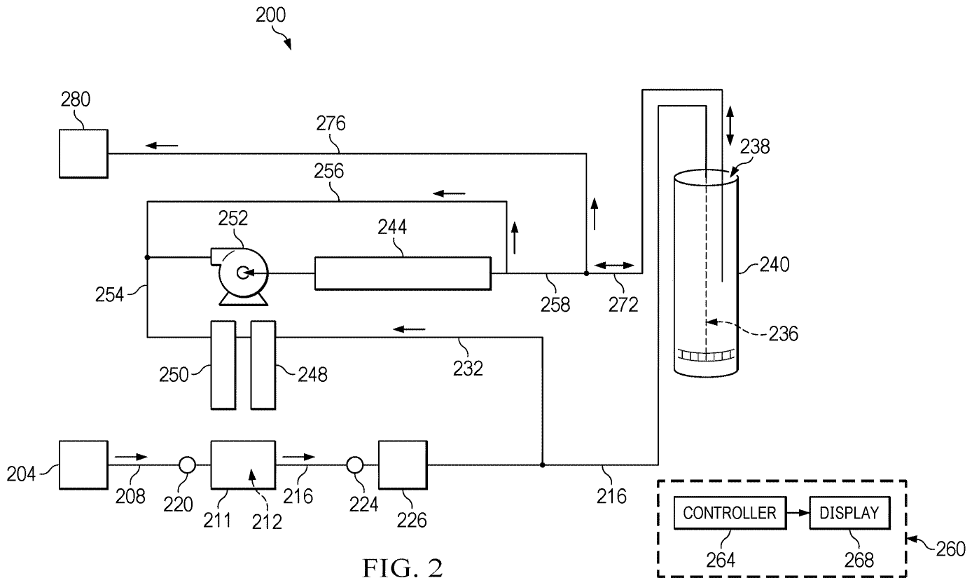

FIG. 2 depicts a visual representation of a water treatment system 200. The water treatment system 200 may be provided in the form of an inlet 204, a prefiltration unit 211 designed to remove substances (e.g., disinfectants) from a water stream, a tank 240, a membrane element 244, a feeder 248, a second prefiltration unit 250, an outlet 280, and one or more conduit lines fluidly coupling the aforementioned components. The water treatment system 200 may be similar to the water treatment systems described in U.S. patent application Ser. No. 18/394,993, titled “Self-Mediated Saltless Whole Home Water Treatment Systems and Methods,” the disclosure of which is incorporated by reference in its entirety herein. The inlet 204 may facilitate entry of untreated water into the water treatment system 200. The inlet 204 of the water treatment system 200 may be in fluid communication with an inlet line 208. The untreated water may be from an inlet water source, such as a municipal water source, a well, or other influent water source. A prefiltration unit 211 may be in fluid communication with the inlet line 208 such that the untreated water may enter the prefiltration unit 211 via the inlet line 208. The prefiltration unit 211 may further be in fluid communication with the first treated water line 216, such that water in the prefiltration unit 211 may exit the prefiltration unit 211 via the first treated water line 216. When the untreated water passes through the prefiltration unit 211, the prefiltration unit 211 may remove sediment, particulates, certain chemicals (e.g., chloramine), and other contaminants from the untreated water, producing a first treated water that may flow out of the prefiltration unit 211 via the first treated water line 216.

In some instances, the prefiltration unit 211 may be provided in the form of one or more prefilter elements having filter media. In some instances, a prefilter element may include a sediment filter to remove sediments such as sand, silt, and dirt, and other particulates such as rust from the inlet water. In other instances, the prefiltration unit 211 may include media to remove disinfectants or contaminants. The media may be provided in the form of carbon-rich filter media, granular activated carbon, an activated carbon block, or activated carbon suspended in a fibrous matrix. In yet other instances, the prefiltration unit 211 may include other non-carbon-based media, such as clay or an ion-exchange media.

The prefiltration unit 211 may also include a disinfectant removal system comprising an iron media bed 212. In some instances, the iron media bed 212 may be comprised of, consist essentially of, or consist of iron particles. The iron media bed 212 may be designed to remove certain chemicals such as chlorine, chloramine, chlorine dioxide, ozone, and other disinfectants from the untreated water via a chemical reduction process. In certain instances, the iron media bed 212 may also be effective in removing other aqueous chemicals, such as disinfectant byproducts and/or volatile organic compounds, from the untreated water. For instance, the iron particles may provide a surface to which the oxidizing disinfectants in the untreated water may adsorb, thereby promoting electron exchange. In some cases, the iron media bed 212 may be provided as a rigid, non-compressible media. In addition, the iron media bed 212 may be designed to have a low pressure drop when implemented and a long contact time with untreated water. Thus, the iron media bed 212 may facilitate high throughput of the untreated water and substantially complete or complete disinfectant destruction (e.g., chloramine destruction).

Without being bound by a particular theory, in certain instances, a product of the redox reaction between the particles of the iron media bed 212 and the disinfectants may be an iron oxide. In certain cases, the iron oxide compound may absorb or adsorb unwanted heavy metals from water. For example, the iron oxide may absorb or adsorb heavy metals such as chromium, arsenic (e.g., arsenic (V)), lead, and other heavy metals from the water. Thus, in certain cases, the iron media bed 212 may absorb or adsorb disinfectants, VOCs, and heavy metals from an inlet water provided to the iron media bed 212.

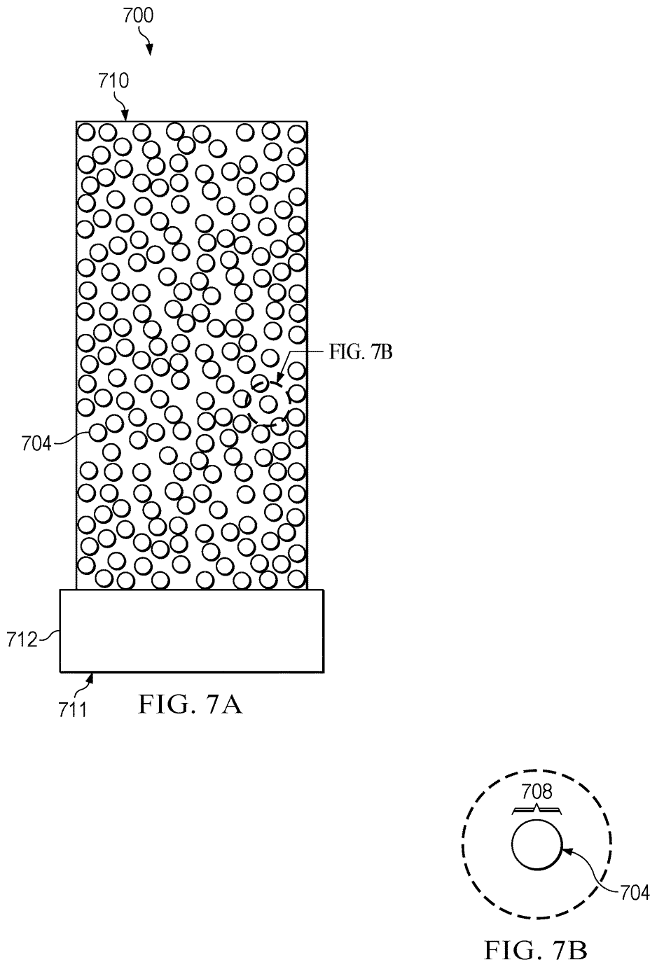

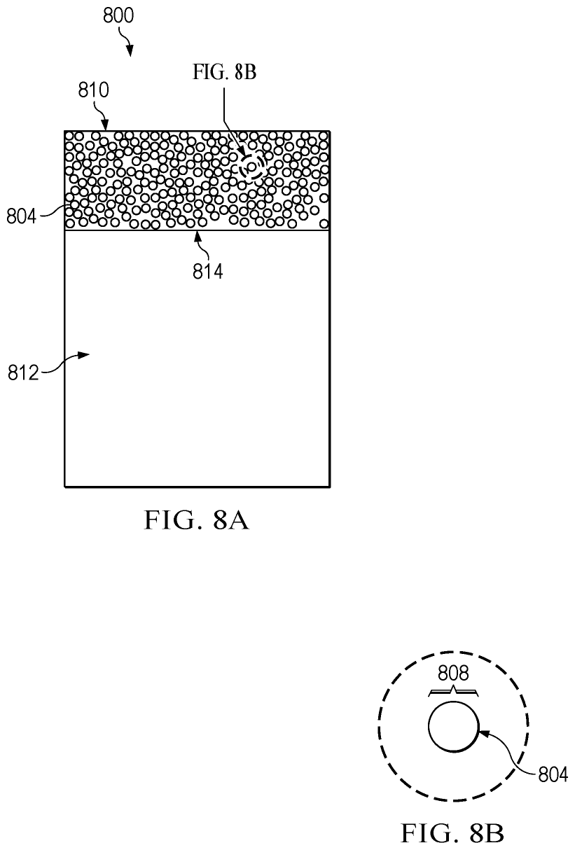

The iron media bed 212 may comprise, consist essentially of, or consist of zero-valent iron particles. In some instances, for example, the iron media bed 212 is comprised substantially of zero-valent iron particles throughout the depth of the bed (see FIG. 7A). In another instance, the bed may be comprised of a different material and coated with zero-valent iron particles on the surface (see FIG. 8A).

It is to be understood that the one or more elements that comprise the prefiltration unit 211 may be retained within a single prefiltration apparatus or may be separate and distinct prefilter apparatuses that are in fluid communication with one another.

By removing chlorine, chloramine, chlorine dioxide, ozone, sediment, sand, silt, dirt, particulates, and other impurities, the prefiltration unit 211 may provide the first treated water imparted with more desirable properties than the untreated water. For example, the first treated water may be imparted with a reduced odor, substantially no odor, or no odor and an improved taste compared to the untreated water. In addition, the prefiltration unit 211 may protect the membrane element 244, which is positioned downstream of the prefiltration unit 211, from fouling or oxidation.

In some instances, the untreated water may be imparted with a first concentration of disinfectants and the first treated water may be imparted with a second concentration of disinfectants. In some instances, the disinfectants may comprise, consist essentially of, or consist of oxidizing disinfectants. For example, the disinfectants may include, but are not limited to, chloramine, chlorine, ozone, and chlorine dioxide. As an additional example, the disinfectants may include chlorine-containing ions and ozone. As yet another example, the disinfectants may be selected from the group consisting of chloramine, chlorine, ozone, and chlorine dioxide. As a further example, the disinfectant may be provided in the form of chloramine. In certain instances, the untreated water may be imparted with a third concentration of other aqueous substances, the aqueous contaminants including VOCs, heavy metals, and/or disinfectant byproducts, such as the chloronitramide anion. In alternative instances, the disinfectants may include little or substantially no oxidizing disinfectants and/or oxidizing agents. In various cases, the disinfectants may be entrained within, dissolved in, or suspended within the water streams flowing through the water treatment system 200. For example, the disinfectants may be aqueous components of water provided to the water treatment system 200.

In some instances, the untreated water may be imparted with a first concentration of disinfectants of at least about 5 mg/L (5 ppm). For example, the untreated water may be imparted with a concentration of disinfectants of at least about 0.1 mg/L (0.1 ppm), or at least about 0.5 mg/L (0.5 ppm), or at least about 1 mg/L (1 ppm), or at least about 3 mg/L (3 ppm), or at least about 10 mg/L (10 ppm), or at least about 20 mg/L (20 ppm), or at least about 30 mg/L (30 ppm), or at least about 45 mg/L (45 ppm), or at least about 100 mg/L (100 ppm). In other instances, the untreated water may comprise water imparted with a concentration of disinfectants of at least 0.1 mg/L (0.1 ppm), or at least 0.5 mg/L (0.5 ppm), or at least 1 mg/L (1 ppm), or at least 3 mg/L (3 ppm), or at least 10 mg/L (10 ppm), or at least 20 mg/L (20 ppm), or at least 30 mg/L (30 ppm), or at least 45 mg/L (45 ppm), or at least 100 mg/L (100 ppm). In certain instances, the untreated water may be imparted with a concentration of disinfectants that may be greater than the values recited herein. In some instances, the untreated water may be imparted with a concentration of disinfectants that falls within a range bounded by any minimum value and any maximum value as described above.

In some instances, the first treated water may be imparted with a second concentration of disinfectants of about 0 mg/L (0 ppm) to about 5 mg/L (5 ppm). For example, the first treated water may be imparted with a concentration of disinfectants of no more than about 0.1 mg/L (0.1 ppm), or no more than about 0.25 mg/L (0.25 ppm), or no more than about 0.5 mg/L (0.5 ppm), or no more than about 0.75 mg/L (0.75 ppm), or no more than about 1 mg/L (1 ppm), or no more than about 1.5 mg/L (1.5 ppm), or no more than about 2 mg/L (2 ppm), or no more than about 2.5 mg/L (2.5 ppm), or no more than about 3 mg/L (3 ppm), or no more than about 4.5 mg/L (4.5 ppm). In other instances, the first treated water may comprise water imparted with a concentration of disinfectants of no more than 0.1 mg/L (0.1 ppm), or no more than 0.25 mg/L (0.25 ppm), or no more than 0.5 mg/L (0.5 ppm), or no more than 0.75 mg/L (0.75 ppm), or no more than 1 mg/L (1 ppm), or no more than 1.5 mg/L (1.5 ppm), or no more than 2 mg/L (2 ppm), or no more than 2.5 mg/L (2.5 ppm), or no more than 3 mg/L (3 ppm), or no more than 4.5 mg/L (4.5 ppm). In certain cases, the first treated water may be imparted with a concentration of disinfectants of no more than about 4 mg/L (4 ppm) or no more than 4 mg/L (4 ppm). In certain instances, the first treated water may be imparted with a concentration of disinfectants that may be somewhat greater than the values recited herein. In some instances, the first treated water may be imparted with a concentration of disinfectants that falls within a range bounded by any minimum value and any maximum value as described above. In other instances, a maximum value of the concentration of a disinfectant may be selected based on the identity of the disinfectant. For example, a concentration of aqueous ozone in the first treated water may only be about 2 mg/L (2 ppm), or less.

Treatment of a water stream by the iron media bed 212 may reduce the concentration of disinfectants in the water stream by about 30% to about 100% (or 30% to 100%). For example, the second concentration of disinfectants may be at least about 30% less, or at least about 40% less, or at least about 50% less, or at least about 60% less, or at least about 70% less, or at least about 80% less, or at least about 90% less, or at least about 95% less, or at least about 96% less, or at least about 97% less, or at least about 98% less, or at least about 99% less, or at least about 99.5% less, or at least about 99.7% less, or at least about 99.8% less, or at least about 99.9% less, or at least about 100% less than the first concentration of disinfectants. In other instances, treatment of the untreated water by the iron media bed 212 may impart the first treated water with a reduction in the concentration of disinfectants of between 30 and 100%. For example, in some instances, the second concentration of disinfectants may be at least 30% less, or at least 40% less, or at least 50% less, or at least 60% less, or at least 70% less, or at least 80% less, or at least 90% less, or at least 95% less, or at least 96% less, or at least 97% less, or at least 98% less, or at least 99% less, or at least 99.5% less, or at least 99.7% less, or at least 99.8% less, or at least 99.9% less, or at least 100% less than the first concentration of disinfectants.

In certain instances, the first treated water may be imparted with a second concentration of aqueous contaminants (e.g., VOCs, heavy metals, disinfectant byproducts) that is less than the first concentration of aqueous contaminants. For example, the first concentration of aqueous contaminants may be imparted with a value of at least about 5 mg/L (5 ppm) to at least about 100 mg/L (100 ppm) and the second concentration of aqueous contaminants may be imparted with a value that is less than the first concentration. In such instances, the untreated water may be imparted with a concentration of aqueous contaminants of at least about 0.1 mg/L (0.1 ppm), or at least about 0.5 mg/L (0.5 ppm), or at least about 1 mg/L (1 ppm), or at least about 3 mg/L (3 ppm), or at least about 10 mg/L (10 ppm), or at least about 20 mg/L (20 ppm), or at least about 30 mg/L (30 ppm), or at least about 45 mg/L (45 ppm), or at least about 100 mg/L (100 ppm). In other such instances, the untreated water may comprise water imparted with a concentration of aqueous contaminants of at least 0.1 mg/L (0.1 ppm), or at least 0.5 mg/L (0.5 ppm), or at least 1 mg/L (1 ppm), or at least 3 mg/L (3 ppm), or at least 10 mg/L (10 ppm), or at least 20 mg/L (20 ppm), or at least 30 mg/L (30 ppm), or at least 45 mg/L (45 ppm), or at least 100 mg/L (100 ppm). In addition, the first treated water may be imparted with a concentration of aqueous contaminants of no more than about 0.1 mg/L (0.1 ppm), or no more than about 0.25 mg/L (0.25 ppm), or no more than about 0.5 mg/L (0.5 ppm), or no more than about 0.75 mg/L (0.75 ppm), or no more than about 1 mg/L (1 ppm), or no more than about 1.5 mg/L (1.5 ppm), or no more than about 2 mg/L (2 ppm), or no more than about 2.5 mg/L (2.5 ppm), or no more than about 3 mg/L (3 ppm), or no more than about 4.5 mg/L (4.5 ppm). In other such instances, the first treated water may comprise water imparted with a concentration of aqueous contaminants of no more than 0.1 mg/L (0.1 ppm), or no more than 0.25 mg/L (0.25 ppm), or no more than 0.5 mg/L (0.5 ppm), or no more than 0.75 mg/L (0.75 ppm), or no more than 1 mg/L (1 ppm), or no more than 1.5 mg/L (1.5 ppm), or no more than 2 mg/L (2 ppm), or no more than 2.5 mg/L (2.5 ppm), or no more than 3 mg/L (3 ppm), or no more than 4.5 mg/L (4.5 ppm). In certain instances, the untreated water and the first treated water may be imparted with a concentration of aqueous contaminants that may be somewhat greater than the values recited herein. In some instances, the untreated water and the first treated water may be imparted with a concentration of aqueous contaminants that falls within a range bounded by any minimum value and any maximum value as described above.

Treatment of a water stream by the iron media bed 212 may reduce the concentration of aqueous contaminants (e.g., VOCs, heavy metals, disinfectant byproducts) in the water stream by about 30% to about 100% (or 30% to 100%). For example, the second concentration of aqueous contaminants may be at least about 30% less, or at least about 40% less, or at least about 50% less, or at least about 60% less, or at least about 70% less, or at least about 80% less, or at least about 90% less, or at least about 95% less, or at least about 96% less, or at least about 97% less, or at least about 98% less, or at least about 99% less, or at least about 99.5% less, or at least about 99.7% less, or at least about 99.8% less, or at least about 99.9% less, or at least about 100% less than the first concentration of aqueous contaminants. In other instances, treatment of the untreated water by the iron media bed 212 may impart the first treated water with a reduction in the concentration of aqueous contaminants of between 30 and 100%. For example, in some instances, the second concentration of aqueous contaminants may be at least 30% less, or at least 40% less, or at least 50% less, or at least 60% less, or at least 70% less, or at least 80% less, or at least 90% less, or at least 95% less, or at least 96% less, or at least 97% less, or at least 98% less, or at least 99% less, or at least 99.5% less, or at least 99.7% less, or at least 99.8% less, or at least 99.9% less, or at least 100% less than the first concentration of aqueous contaminants.

In some cases, the untreated water may be imparted with a first concentration of chloramine of at least about 5 mg/L (5 ppm). For example, the untreated water may be imparted with a concentration of chloramine of at least about 0.1 mg/L (0.1 ppm), or at least about 0.5 mg/L (0.5 ppm), or at least about 1 mg/L (1 ppm), or at least about 3 mg/L (3 ppm), or at least about 10 mg/L (10 ppm), or at least about 20 mg/L (20 ppm), or at least about 30 mg/L (30 ppm), or at least about 45 mg/L (45 ppm), or at least about 100 mg/L (100 ppm). In other instances, the untreated water may comprise water imparted with a concentration of chloramine of at least 0.1 mg/L (0.1 ppm), or at least 0.5 mg/L (0.5 ppm), or at least 1 mg/L (1 ppm), or at least 3 mg/L (3 ppm), or at least 10 mg/L (10 ppm), or at least 20 mg/L (20 ppm), or at least 30 mg/L (30 ppm), or at least 45 mg/L (45 ppm), or at least 100 mg/L (100 ppm). The first treated water may be imparted with a second concentration of chloramine of about 0 mg/L (0 ppm) to about 5 mg/L (5 ppm). For example, the first treated water may be imparted with a concentration of chloramine of no more than about 0.1 mg/L (0.1 ppm), or no more than about 0.25 mg/L (0.25 ppm), or no more than about 0.5 mg/L (0.5 ppm), or no more than about 0.75 mg/L (0.75 ppm), or no more than about 1 mg/L (1 ppm), or no more than about 1.5 mg/L (1.5 ppm), or no more than about 2 mg/L (2 ppm), or no more than about 2.5 mg/L (2.5 ppm), or no more than about 3 mg/L (3 ppm), or no more than about 4.5 mg/L (4.5 ppm). In other instances, the first treated water may comprise water imparted with a concentration of chloramine of no more than 0.1 mg/L (0.1 ppm), or no more than 0.25 mg/L (0.25 ppm), or no more than 0.5 mg/L (0.5 ppm), or no more than 0.75 mg/L (0.75 ppm), or no more than 1 mg/L (1 ppm), or no more than 1.5 mg/L (1.5 ppm), or no more than 2 mg/L (2 ppm), or no more than 2.5 mg/L (2.5 ppm), or no more than 3 mg/L (3 ppm), or no more than 4.5 mg/L (4.5 ppm). In some cases, the first treated water is imparted with a concentration of chloramine of no more than about 4 mg/L (4 ppm) or no more than 4 mg/L (4 ppm). In certain instances, the first treated water may be imparted with a concentration of chloramine that may be somewhat greater than the values recited herein. In some instances, the first treated water may be imparted with a concentration of chloramine that falls within a range bounded by any minimum value and any maximum value as described above.

Referring still to FIG. 2, in various instances, treatment of a water stream by the iron media bed 212 may reduce the concentration of aqueous chloramine in the water stream by about 30% to about 100% (or 30% to 100%). For example, in some instances, the second concentration of chloramine may be at least about 30% less, or at least about 40% less, or at least about 50% less, or at least about 60% less, or at least about 70% less, or at least about 80% less, or at least about 90% less, or at least about 95% less, or at least about 96% less, or at least about 97% less, or at least about 98% less, or at least about 99% less, or at least about 99.5% less, or at least about 99.7% less, or at least about 99.8% less, or at least about 99.9% less, or at least about 100% less than the first concentration of chloramine. In other instances, treatment of the untreated water by the iron media bed 212 may impart the first treated water with a reduction in the concentration of aqueous chloramine of between 30 and 100%. For example, in some instances, the second concentration of chloramine may be at least 30% less, or at least 40% less, or at least 50% less, or at least 60% less, or at least 70% less, or at least 80% less, or at least 90% less, or at least 95% less, or at least 96% less, or at least 97% less, or at least 98% less, or at least 99% less, or at least 99.5% less, or at least 99.7% less, or at least 99.8% less, or at least 99.9% less, or at least 100% less than the first concentration of chloramine.

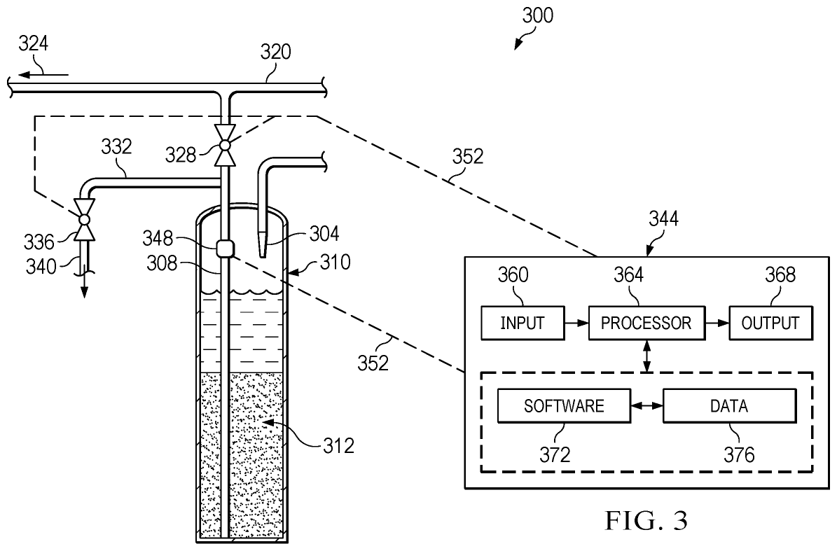

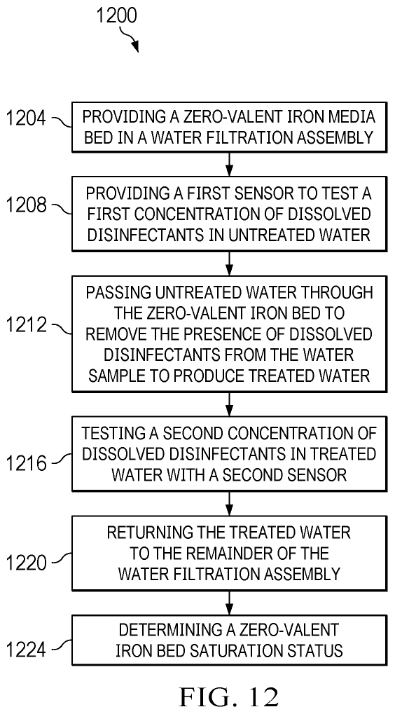

As a result of the reduction and subsequent destruction of the disinfectants, the first treated water may be imparted with a concentration of byproducts such as chloride and hydroxide ions, ammonia, chloronitramide ion, and divalent iron particles. In some instances, the iron particles of the iron media bed 212 may adsorb a percentage of the byproducts, occupying binding sites on the iron media bed 212. Further, as the iron media bed 212 is exposed to water over time, the surface of the iron media bed 212 may experience corrosion or wear, necessitating regeneration. Examples of processes that may be used to regenerate the iron media bed 212 are described with reference to, e.g., FIGS. 3 and 12.

In some such instances, the reduction and subsequent destruction of the disinfectants may impart the first treated water with a concentration of metal-adsorbing iron oxides. In such instances, the iron oxides still attached to the iron media bed 212 may adsorb a percentage of aqueous metals, including, but not limited to, chromium, arsenic, vanadium, and lead, from the treated water, adding to a need for regeneration of the iron media bed 212 over time owing to saturation of the iron media bed 212 surface with undesirable substances.

It is to be understood that iron media bed 212 may be provided in any of the water treatment systems described herein (e.g., the disinfectant removal system 112 of FIG. 1).

Referring still to FIG. 2, the water treatment system 200 may include one or more sensors. In certain cases, at least one of the one or more sensors may be associated with the prefiltration unit 211. A first sensor 220 may measure, monitor, or sense the untreated water to determine the concentration or amount of disinfectants in the water prior to treatment. The first sensor 220 may be in fluid communication with the inlet line 208. Alternatively, the first sensor 220 may be in fluid communication with water flowing through the prefiltration unit 211. In some cases, the first sensor 220 may be coupled to the inlet line 208. In some instances, the first sensor 220 may be coupled to the prefiltration unit 211.

In some instances, a second sensor 224 may be included in the water treatment system 200. The second sensor 224 may be positioned downstream of the prefiltration unit 211. In some instances, the second sensor 224 may be in fluid communication with the first treated water line 216. The second sensor 224 may measure, monitor, or sense the first treated water to determine the concentration or amount of disinfectants remaining in the water after treatment.

The water treatment system 200 may further include one or more sensors (not shown), where the one or more sensors may include temperature, pressure, or pH sensors that may be in fluid communication with the inlet line 208 and/or the first treated water line 216. The one or more sensors may be designed to measure, monitor, or sense one or more parameters of the untreated water and/or the first treated water, such as temperature, pressure, or pH. In some instances, one or more sensors may be included in other components of the water treatment system 200. It is to be understood that while higher temperatures may correlate with a faster reaction rate of the disinfectant compounds with the iron particles, optimal operating conditions for the water treatment system 200 may be at or around ambient conditions.

The water treatment system 200 may include one or more flowmeters 226 designed to measure a volume of water flow. In some instances, the one or more flowmeters 226 may be provided as a mechanical flowmeter or an ultrasonic flowmeter. It is to be understood that each of the one or more flowmeters 226 may be the same type of flowmeter or may each be a different type of flowmeter. In some instances, the one or more flowmeters 226 may measure, monitor, or sense the flow rate of the first treated water through the first treated water line 216. In some instances, the first and second sensors 220, 224 may be in electronic communication with the one or more flowmeters 226, such that the first and second sensors 220, 224 may measure the concentration of disinfectants in the untreated and/or first treated water over regular intervals determined by water volume.

After exiting the prefiltration unit 211, the first treated water may follow various fluid flow paths through the water treatment system 200. In some instances, depending on the flow conditions and end-user requirements, when the water treatment system 200 is in use, the first treated water may flow in different directions, as described in more detail below.

In some instances, after exiting the prefiltration unit 211, the first treated water may flow through the first treated water line 216. The first treated water line 216 may be in fluid communication with a riser tube 236, such that the first treated water may flow from the first treated water line 216 to the riser tube 236. The riser tube 236 may be disposed, arranged, and/or contained within the tank 240, such that the riser tube 236 may be in fluid communication with an interior volume of the tank 240. The tank 240 may be placed in fluid communication with the membrane element 244 and the outlet 280. In some instances, the first treated water may be stored in the tank 240 for future processing by the membrane element 244 of the water treatment system 200. In other instances, the first treated water may also flow into and through the tank 240 to the outlet 280 of the water treatment system 200 for immediate use.

In some instances, the tank 240 may be a flow-through tank, which may allow for the seamless delivery of water to a point of use (POU) (e.g., the outlet 280). In some instances, the tank 240 may be a pressurized tank. In some instances, the tank 240 may be a fiberglass-reinforced plastic (FRP) tank. In some instances, the tank 240 may range in size from about 24 gallons (91 liters) to about 200 gallons (757 liters). In some instances, the water treatment system may include a plurality of tanks, where the plurality of tanks may be provided in the form of tanks of any size that may be connected in series. In further instances, existing water vessels within the residential or commercial property (e.g., a water heater) may be used for additional storage capacity in the water treatment system 200. In such instances, the existing water vessels may be placed in fluid communication with one or more elements of the water treatment system 200.

Still referring to FIG. 2, the riser tube 236 may be designed to control the flow of the first treated water into the tank 240. The riser tube 236 may extend vertically through the tank, such that the riser tube 236 extends from the bottom portion of the tank 240 to the top portion of the tank 240, or vice versa. In some instances, the riser tube 236 may be provided as PVC tubing. The tank 240 may further include a tank outlet 238, which may be placed in fluid communication with the riser tube 236. In some instances, the riser tube 236 may be physically attached or coupled to the tank outlet 238.

Alternatively, or additionally, during other flow conditions, the first treated water may flow toward the membrane element 244 via an additive line 232. The additive line 232 may be physically connected to or otherwise in fluid communication with the first treated water line 216. In some instances, the feeder 248 may be in fluid communication with the additive line 232. In such instances, as the first treated water flows toward the membrane element 244, the treated water may pass the feeder 248. If provided, in some instances, the feeder 248 may be positioned elsewhere in the water treatment system 200 (e.g., downstream of the pump 252 or downstream of the membrane element 244). The feeder 248 may introduce or add a chemical additive to the first treated water. In some instances, the chemical additive may be an anti-scaling agent designed to reduce corrosion or scale on a feed side of a membrane element. In some instances, the chemical additive may be a polyphosphate. The chemical additive may dissolve or otherwise degrade in the first treated water. In some instances, as further detailed herein, the feeder 248 may impart the first treated water flowing through the feeder 248 with a chemical additive concentration of at least about 0.01 ppm to at least about 10 ppm (or at least 0.01 ppm to at least 10 ppm). For example, the feeder 248 may dose the first treated water with a chemical additive concentration of at least about 0.01 ppm, or at least about 0.1 ppm, or at least about 1 ppm, or at least about 2 ppm, or at least about 3 ppm, or at least about 4 ppm, or at least about 5 ppm, or at least about 6 ppm, or at least about 7 ppm, or at least about 8 ppm, or at least about 9 ppm, or at least about 10 ppm. As an additional example, the feeder 248 may dose the first treated water with a chemical additive concentration of at least 0.01 ppm, or at least 0.1 ppm, or at least 1 ppm, or at least 2 ppm, or at least 3 ppm, or at least 4 ppm, or at least 5 ppm, or at least 6 ppm, or at least 7 ppm, or at least 8 ppm, or at least 9 ppm, or at least 10 ppm. In other instances, the feeder 248 may impart the water flowing through the feeder 248 with a chemical additive concentration of less than 0.01 ppm or greater than 10 ppm of the chemical additive.

Referring again to FIG. 2, in some instances, the water treatment system 200 may include the second prefiltration unit 250. The second prefiltration unit 250 may be in fluid communication with the additive line 232 and, in instances where the water treatment system 200 includes the feeder 248, the second prefiltration unit 250 may be placed in fluid communication with the feeder 248. The second prefiltration unit 250 may be provided in the form of one or more prefilter elements having one or more filter media. For example, the second prefiltration unit 250 may include a second sediment filter or iron media bed to remove remaining sediment, sand, silt, dirt, disinfectants, and other particulates from the first treated water (with or without additive) that were not removed by the prefiltration unit 211 to produce a second treated water. In certain cases, the second prefiltration unit 250 may include the iron media bed 212 described with reference to the prefiltration unit 211. The second prefiltration unit 250 may be in fluid communication with a membrane feed line 254, such that the second prefiltration unit 250 is placed in fluid communication with the membrane element 244. Where the water treatment system 200 includes the feeder 248 and the second prefiltration unit 250, the feeder 248 and the second prefiltration unit 250 may provide a second treated water to the membrane feed line 254.

A pump 252 may be disposed on a feed side of the membrane element 244. The pump 252 may be designed to direct the first or second treated water toward the membrane element 244. The membrane element 244 may further filter the first or second treated water to remove hardness-imparting minerals and other impurities. An inlet side (not shown) of the pump 252 may be in fluid communication with the additive line 232, and an outlet side (not shown) of the pump 252 may be in fluid communication with the membrane feed line 254.

In some instances, when the pump 252 is activated, the pump 252 may increase the rate at which water flows into the membrane feed line 254 toward the membrane element 244. Increasing the flow rate of water into the membrane feed line 254 may increase pressure in the membrane feed line 254.

After fluid passes through the membrane element 244, a permeate water stream may be provided from the membrane element 244. The permeate water stream may exit the membrane element 244 and be provided to the permeate line 258. In some instances, at least a portion of the permeate water stream may flow from the permeate line 258 to a recirculation line 256 to be re-processed by the membrane element 244. In certain cases, at least a portion of the permeate water stream may be provided to the tank line 272 for storage. In various instances, at least a portion of the permeate water stream may be provided from the permeate line 258 to an outlet feed line 276, where the permeate water stream may ultimately flow to an outlet 280. It is to be appreciated that the permeate water stream provided from the membrane element 244 may be a third treated water, as further described below.

During further flow conditions, the first treated water may flow from the bottom portion of the tank 240, up the riser tube 236, and through the first treated water line 216 toward the membrane element 244 via the additive line 232.

The membrane element 244 may be designed to filter or remove hardness-imparting minerals—such as divalent and/or trivalent ions—from the water, replacing the divalent and/or trivalent ions with monovalent ions. The first or second treated water may be imparted with a first total dissolved solids (TDS) value. In some instances, treatment by the membrane element 244 may provide a third treated water with a second TDS value that is lower than the first TDS value. In other instances, replacement of the divalent and/or trivalent ions in the hard water by a higher concentration of monovalent ions may effectively increase the TDS value of the first treated water after softening.

In some instances, the membrane element 244 may be a reverse osmosis (RO) membrane. In some instances, the membrane element 244 may be a nanofiltration (NF) membrane, an ultrafiltration (UF) membrane, a microfiltration (MF) membrane, or a particulate membrane. In some instances, the membrane element 244 may be a hollow fiber NF membrane. In other instances, the membrane element 244 may be an electrodialysis membrane system. In some instances, the membrane element 244 may comprise a combination of one or more of a RO membrane, a NF membrane, a UF membrane, a MF membrane, a particulate membrane, and/or an electrodialysis membrane, which may be disposed in parallel or in series. The one or more membranes in the combination of membranes may be included within a single housing, in separate housings, or a combination thereof.

The water treatment system 200 may include one or more valves (not illustrated), such as butterfly valves, ball valves, globe valves, pressure relief valves, or gate valves, that may be in fluid communication with the first treated water line 216, the additive line 232, and/or other lines provided in the water treatment system 200. The valves may be designed to control or regulate the water pressure in the water treatment system 200 in response to a reading by the one or more flowmeters 226.

The water treatment system 200 may include and be in communication with a control system 260. In certain instances, the control system 260 may be substantially similar to the control system 160 of FIG. 1. For example, the control system 260 may include the central controller 264 and a display 268. The central controller 264 may be electronically connected to and may be in electronic communication with the display 268. The central controller 264 also may be electronically connected to and may be in electronic communication with one or more of the water treatment system components, including the one or more of the first and second sensors 220, 224, the one or more flowmeters 226, the feeder 248, the pump 252, and/or one or more local controllers. In some cases, the central controller 264 may receive various inputs from the components of the water treatment system 200 and direct operation of the water treatment system 200 based at least partially on the inputs.

The first or second treated water that may be stored in the tank 240 may flow through a tank line 272 and an outlet feed line 276 out of the outlet 280. In some instances, depending on flow conditions, when the water treatment system 200 is in use, water exiting the membrane element 244 may be recirculated through the membrane feed line 254 and into the feed side of the membrane element 244. This recirculation may be aided by the pump 252 when activated or may be caused by pressure within the water treatment system 200 when the pump 252 is turned off.

Referring now to FIG. 3, the disinfectant removal system 112 or the prefiltration unit 211 of FIGS. 1 and 2, respectively, may comprise a disinfectant removal system 300. The disinfectant removal system 300 may include at least one inlet 304, an outlet conduit 308, a treatment tank 310 including an iron media bed 312, an output line 320, an outlet 324, an output valve 328, a drain line 332, a drain valve 336, a drain 340, a local controller 344, a sensor 348, and a communication link 352. In certain instances, the iron media bed 312 may be provided as the iron media bed 212 of FIG. 2. Thus, the disinfectant removal system 300 may be designed to process an untreated water to generate a treated water that is partially, substantially, or completely free of one or more disinfectants (e.g., chloramine).

The local controller 344 may receive data from one or more of the components of the disinfectant removal system 300 and analyze the data as discussed herein. Thus, the local controller 344 may provide a communication link that operatively connects the plurality of system components of the disinfectant removal system 300. Accordingly, the local controller 344 may include one or more of an input 360, a processor 364, and an output 368. The input 360 may be designed to receive transmitted data 376 from the disinfectant removal system 300 through, for example, the sensor 348 to monitor various system operational parameters. In some instances, the input 360 may receive data inputs from a user. For example, a user may manually input a preferred schedule for regeneration of the iron media bed 312. The processor 364 may be a programmable processor that may be communicatively coupled to the software 372. In some embodiments, the programmable processor 364 may include program instructions that are stored on a cloud server or a non-transitory computer-readable medium and that are executable by the programmable processor to perform one or more of the methods described herein. Software 372 may be designed to store system information received from the one or more system components and/or user inputs. In some instances, the software 372 may be integrated with one or more of the system components discussed herein. In other instances, the software 372 may be implemented as a standalone memory unit. The output 368 may be designed to send the instructions from the processor 364 to the one or more system components. In addition, the local controller 344 may be in wired or wireless communication with a central controller (e.g., the central controller 164, 264 of FIGS. 1 and 2, respectively) provided as part of a residential or commercial water system (e.g., the home water system 100 of FIG. 1 or the water treatment system 200 of FIG. 2). Thus, actions taken by the disinfectant removal system 300 components may be automated.

One or more of the conduits and lines of the disinfectant removal system may be designed to place various components of the disinfectant removal system 300 into fluid communication. For example, the at least one inlet 304 may supply untreated water from the home water system to the treatment tank 310 for removal of disinfectants or contaminants, and the outlet conduit 308, output line 320, and drain line 332 may be designed to facilitate the flow of untreated water, treated water, and acid solutions throughout the disinfectant removal system 300. One or more of the conduits and lines may be provided in the form of substantially hollow cylinders, although the conduits and lines may also be provided in other shapes. One or more of the conduits and lines may be constructed of a rust-resistant material, such as stainless steel, PVC, or copper alloys, although the conduits and lines may also be constructed from other materials. In certain instances, the disinfectant removal system 300 may not be provided with the conduits or lines and instead be coupled to preexisting lines of a residential or commercial water system.

The treatment tank 310 may be designed to facilitate the removal of disinfectants or contaminants from a water stream. The treatment tank 310 may be provided in the form of a substantially hollow cylinder, although the treatment tank 310 may also be provided in other shapes (e.g., cube, rectangular prism, cuboid, pyramid, parallelepiped, and trapezoidal prism shapes). After passing through the iron media bed 312, treated water may travel through the outlet conduit 308 to the remainder of the water system by passing through output valve 328 and entering output line 320.

In some instances, the untreated water may be imparted with a first concentration of disinfectants of at least about 5 mg/L (5 ppm). For example, the untreated water may be imparted with a concentration of disinfectants of at least about 0.1 mg/L (0.1 ppm), or at least about 0.5 mg/L (0.5 ppm), or at least about 1 mg/L (1 ppm), or at least about 3 mg/L (3 ppm), or at least about 10 mg/L (10 ppm), or at least about 20 mg/L (20 ppm), or at least about 30 mg/L (30 ppm), or at least about 45 mg/L (45 ppm), or at least about 100 mg/L (100 ppm). In other instances, the untreated water may comprise water imparted with a concentration of disinfectants of at least 0.1 mg/L (0.1 ppm), or at least 0.5 mg/L (0.5 ppm), or at least 1 mg/L (1 ppm), or at least 3 mg/L (3 ppm), or at least 10 mg/L (10 ppm), or at least 20 mg/L (20 ppm), or at least 30 mg/L (30 ppm), or at least 45 mg/L (45 ppm), or at least 100 mg/L (100 ppm). In certain instances, the untreated water may be imparted with a concentration of disinfectants that may be somewhat greater than the values recited herein. In some instances, the untreated water may be imparted with a concentration of disinfectants that falls within a range bounded by any minimum value and any maximum value as described above.

In some instances, after passing through the iron media bed 312, the treated water may be imparted with a second concentration of disinfectants of about 0 mg/L (0 ppm) to about 5 mg/L (5 ppm). For example, the treated water may be imparted with a concentration of disinfectants of no more than about 0.1 mg/L (0.1 ppm), or no more than about 0.25 mg/L (0.25 ppm), or no more than about 0.5 mg/L (0.5 ppm), or no more than about 0.75 mg/L (0.75 ppm), or no more than about 1 mg/L (1 ppm), or no more than about 1.5 mg/L (1.5 ppm), or no more than about 2 mg/L (2 ppm), or no more than about 2.5 mg/L (2.5 ppm), or no more than about 3 mg/L (3 ppm), or no more than about 4.5 mg/L (4.5 ppm). In other instances, the treated water may comprise water imparted with a concentration of disinfectants of no more than 0.1 mg/L (0.1 ppm), or no more than 0.25 mg/L (0.25 ppm), or no more than 0.5 mg/L (0.5 ppm), or no more than 0.75 mg/L (0.75 ppm), or no more than 1 mg/L (1 ppm), or no more than 1.5 mg/L (1.5 ppm), or no more than 2 mg/L (2 ppm), or no more than 2.5 mg/L (2.5 ppm), or no more than 3 mg/L (3 ppm), or no more than 4.5 mg/L (4.5 ppm). In certain cases, the treated water is imparted with a concentration of disinfectants of no more than about 4 mg/L (4 ppm) or no more than 4 mg/L (4 ppm). In certain instances, the treated water may be imparted with a concentration of disinfectants that may be somewhat greater than the values recited herein. In some instances, the treated water may be imparted with a concentration of disinfectants that falls within a range bounded by any minimum value and any maximum value as described above. In other instances, a preferred maximum value of the concentration of a disinfectant may be selected based on the identity of the disinfectant. For example, a concentration of aqueous ozone may only be about 2 mg/L (2 ppm).

In other instances, the untreated water may be imparted with a first concentration of chloramine of at least about 5 mg/L (5 ppm). For example, the untreated water may be imparted with a concentration of chloramine of at least about 0.1 mg/L (0.1 ppm), or at least about 0.5 mg/L (0.5 ppm), or at least about 1 mg/L (1 ppm), or at least about 3 mg/L (3 ppm), or at least about 10 mg/L (10 ppm), or at least about 20 mg/L (20 ppm), or at least about 30 mg/L (30 ppm), or at least about 45 mg/L (45 ppm), or at least about 100 mg/L (100 ppm). In certain instances, the untreated water may comprise water imparted with a concentration of chloramine of at least 0.1 mg/L (0.1 ppm), or at least 0.5 mg/L (0.5 ppm), or at least 1 mg/L (1 ppm), or at least 3 mg/L (3 ppm), or at least 10 mg/L (10 ppm), or at least 20 mg/L (20 ppm), or at least 30 mg/L (30 ppm), or at least 45 mg/L (45 ppm), or at least 100 mg/L (100 ppm).

The treated water may be imparted with a second concentration of chloramine of about 0 mg/L (0 ppm) to about 5 mg/L (5 ppm). For example, the treated water may be imparted with a concentration of chloramine of no more than about 0.1 mg/L (0.1 ppm), or no more than about 0.25 mg/L (0.25 ppm), or no more than about 0.5 mg/L (0.5 ppm), or no more than about 0.75 mg/L (0.75 ppm), or no more than about 1 mg/L (1 ppm), or no more than about 1.5 mg/L (1.5 ppm), or no more than about 2 mg/L (2 ppm), or no more than about 2.5 mg/L (2.5 ppm), or no more than about 3 mg/L (3 ppm), or no more than about 4.5 mg/L (4.5 ppm). In other instances, the treated water may comprise water imparted with a concentration of chloramine of no more than 0.1 mg/L (0.1 ppm), or no more than 0.25 mg/L (0.25 ppm), or no more than 0.5 mg/L (0.5 ppm), or no more than 0.75 mg/L (0.75 ppm), or no more than 1 mg/L (1 ppm), or no more than 1.5 mg/L (1.5 ppm), or no more than 2 mg/L (2 ppm), or no more than 2.5 mg/L (2.5 ppm), or no more than 3 mg/L (3 ppm), or no more than 4.5 mg/L (4.5 ppm). In certain cases, the treated water is imparted with a concentration of chloramine of no more than about 4 mg/L (4 ppm) or no more than 4 mg/L (4 ppm). In certain instances, the treated water may be imparted with a concentration of disinfectants that may be somewhat greater than the values recited herein. In some instances, the treated water may be imparted with a concentration of disinfectants that falls within a range bounded by any minimum value and any maximum value as described above.

In various instances, the water entering the disinfectant removal system 300 may be imparted with a first concentration of aqueous chloramine. After treatment, the disinfectant removal system may impart the treated water with a reduction in the concentration of aqueous chloramine of between about 30% and about 100%. For example, in some instances, the second concentration of chloramine may be at least about 30% less, or at least about 40% less, or at least about 50% less, or at least about 60% less, or at least about 70% less, or at least about 80% less, or at least about 90% less, or at least about 95% less, or at least about 99% less than the first concentration of chloramine. In other instances, treatment may impart the treated water with a reduction in the concentration of aqueous chloramine of between 30 and 100%. For example, in some instances, the second concentration of chloramine may be at least 30% less, or at least 40% less, or at least 50% less, or at least 60% less, or at least 70% less, or at least 80% less, or at least 90% less, or at least 95% less, or at least 99% less than the first concentration of chloramine.

In some instances, a sensor 348 may be fluidly coupled to outlet conduit 308, wherein the sensor 348 may be designed to assess the concentration of disinfectants in the treated water. In other instances, the sensor 348 may instead be disposed external to the treatment tank 310. In such instances, the sensor 348 may receive aliquots of water for testing from the drain 340, in which treated water may be dispensed from the outlet conduit 308. The treated water may then flow through the drain line 332 to the drain 340 when the drain valve 336 is open. In some instances, the sensor 348 may determine the concentration of disinfectants in the treated water over specified time intervals. In other instances, the sensor 348 may determine the concentration of disinfectants in the treated water over specified intervals defined by water volume passing through the outlet conduit 308.

Upon testing the treated water, the sensor 348 may send any collected concentration data to the local controller 344 via the communication link 352. The local controller 344 may determine the efficacy of the iron media bed 312 at removal of the disinfectants by, e.g., comparing output concentration values of chloramine, chlorine, ozone, chlorine dioxide, etc. to one or more predetermined threshold concentration values. The local controller 344 may also determine when regeneration of the iron media bed 312 is necessary by, for example, determining a rate of change in the concentration of chloramine, chlorine, ozone, chlorine dioxide, etc. over time. For example, the local controller 344 may determine that regeneration of the iron media bed 312 may be needed when the concentration of disinfectants in the treated water stream increases over time. In such cases, the local controller 344 may determine to initiate regeneration of the iron media bed 312 when the concentration of disinfectants in the treated water stream increases by at least about 10%, or at least about 25%, or at least about 40%, or at least about 50%, or at least about 60%, or at least about 70%, or at least about 80%, or at least about 90%, or at least about 100%, or at least about 150%, or at least about 200%, or at least about 500%, or at least about 1000% over a predetermined period of time. In other such cases, the local controller 344 may determine to initiate regeneration of the iron media bed 312 when the concentration of disinfectants in the treated water stream increases by at least 10%, or at least 25%, or at least 40%, or at least 50%, or at least 60%, or at least 70%, or at least 80%, or at least 90%, or at least 100%, or at least 150%, or at least 200%, or at least 500%, or at least 1000% over a predetermined period of time. In some instances, the local controller 344 may initiate a regeneration of the iron media bed 312 when the increase in the concentration of disinfectants in the treated water stream falls within a range bounded by any minimum value and any maximum value as described above.

Regeneration of the iron media bed 312 may be required when some, substantially all, or all of the particles constituting the iron media bed 312 are saturated with unwanted substances. These unwanted substances may include byproducts released from the reduction reaction that removes the disinfectants from the treated water, VOCs, and adsorbed metals. When saturated, the capacity for the iron media bed 312 particles to accept additional disinfectants via adsorption and facilitate the reduction reaction may be lowered, leading to treatment failure.

The disinfectant removal system 300 may thereby be designed to operate in one or more modes. For example, the disinfectant removal system 300 may operate in at least one of a service mode, a standby mode, and a regeneration mode. In the service mode, untreated water may be supplied to the treatment tank 310, and the iron media bed 312 may provide treated water to the end user via the outlet 324. In the regeneration mode, the disinfectant removal system 300 may regenerate the iron media bed 312. To regenerate the iron media bed, the disinfectant removal system may rinse the iron media bed 312 with a reducing solution and/or an acidic solution. In some instances, the reducing solution may comprise a strong reducing agent, such as sodium borohydride, sodium bisulfite, and formic acid, capable of returning oxidized iron particles constituting the iron media bed 312 to a zero-valence state. In other instances, the aqueous solution may be designed to remove surface corrosion from the iron media bed 312 via an acid wash, comprising an acid solution provided as, for example, hydrochloric acid. In yet other instances, the aqueous solution may comprise an acid wash that both returns the oxidized iron particles of the iron media bed 312 to a zero-valence state and removes surface corrosion. The reducing solution may be supplied to the treatment tank 310 from an acid tank (not shown).

In the standby mode, the acid tank and/or the treatment tank 310 may be fluidly isolated from the output line 320 such that untreated water may be provided to the outlet 324. For example, the standby mode may be initiated when the treated water supplied by the disinfectant removal system 300 is not needed. Each of the modes described herein may be manually selected by the end user and/or automatically initiated by the local controller 344.

The regeneration mode may be initiated when the iron media bed is substantially or completely corroded or includes an excess quantity of adsorbed reduction byproducts and/or aqueous metals. When the iron media bed is substantially exhausted, the iron media bed may have a reduced ability to or may no longer be capable of removing the aqueous disinfectants. In such instances, an alert for regeneration may be provided to the local controller. The local controller 344 may direct actuation of one or more valves (not shown) associated with the at least one inlet 304 to prevent the untreated water from entering or exiting the treatment tank 310 until after the iron media bed 312 has been flushed and/or soaked with a reducing solution and/or an acidic solution. For example, in some instances, the iron media bed 312 may be flushed and/or soaked with an acid wash. In some instances, the regeneration mode comprises treatment by a strong reducing agent, such as sodium borohydride, sodium bisulfite, and formic acid. In other instances, the regeneration mode comprises treatment by a strong acid, such as hydrochloric acid. The reducing solution may be designed to remove unwanted byproducts and impurities from the iron media bed 312. In certain cases, the disinfectant removal system 300 may be coupled to a drain (such as the drain 128 in FIG. 1) to expel used acid or excess water after regeneration has occurred.

In some instances of the regeneration, the iron media bed 312 may be provided with about 100 mL to about 500 mL of the reducing solution, although the amount of the reducing solution provided to the iron media bed 312 may be somewhat less than or even greater than these values. For example, the iron media bed 312 may be dosed with at least about 100 mL, or at least about 150 mL, or at least about 200 mL, or at least about 225 mL, or at least about 250 mL, or at least about 275 mL, or at least about 300 mL, or at least about 325 mL, or at least about 350 mL, or at least about 375 mL, or at least about 400 mL, or at least about 450 mL, or at least about 500 mL of the reducing solution. As an additional example, the iron media bed 312 may be dosed with at least 100 mL, or at least 150 mL, or at least 200 mL, or at least 225 mL, or at least 250 mL, or at least 275 mL, or at least 300 mL, or at least 325 mL, or at least 350 mL, or at least 375 mL, or at least 400 mL, or at least 450 mL, or at least 500 mL of the reducing solution. In some instances, the dose of the reducing solution provided to the iron media bed 312 may fall within a range bounded by any minimum value and any maximum value as described above.

The disinfectant removal system 300 may be returned to the service mode after the regeneration mode is complete by closing the drain valve 336 and drain line 332.

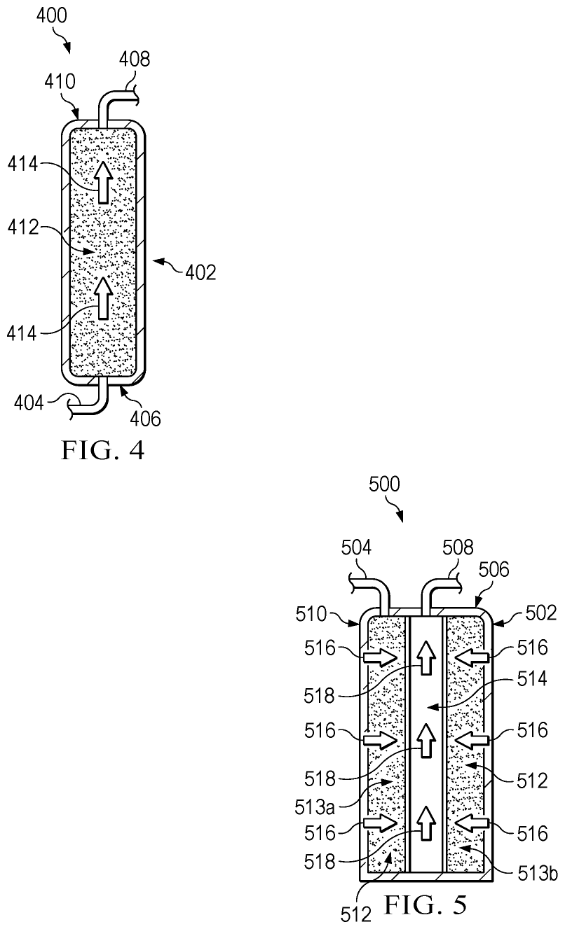

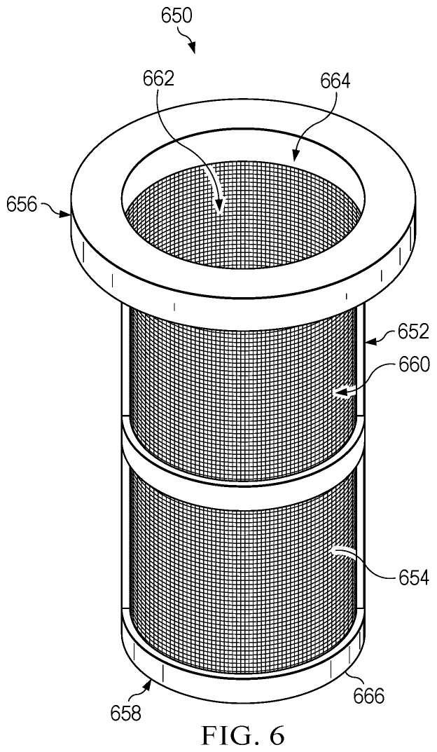

FIGS. 4 and 5 illustrate alternative implementations of a disinfectant removal system 400, 500. In some instances, the disinfectant removal systems 400, 500 may be substantially similar to the disinfectant removal system 300 of FIG. 3, where the disinfectant removal systems 400, 500 may include a tank. The components of a tank 410 of FIG. 4 and a tank 510 of FIG. 5 having similar names and/or element numbers as components of the treatment tank 310 may have substantially the same structure and function as the components of the treatment tank 310. For example, the tanks 410, 510 may include an iron media bed 412, 512 that is substantially similar to the iron media bed 312 of FIG. 3. In addition, the tanks 410, 510 may also include one or more of an inlet 404, 504, an outlet 408, 508, a pump, and, in some instances, a retaining apparatus for the iron media bed 412, 512 (see, e.g., a retaining apparatus 650 of FIG. 6).

Referring to FIG. 4, the disinfectant removal system 400 may include a housing 402. In some instances, the tank 410 may be disposed within the housing 402. In other instances, the housing 402 may be omitted. The tank 410 may include an inlet 404 arranged at a bottom 406 of the tank 410 and an outlet 408 arranged on the tank 410 opposite the inlet 404. Unlike the treatment tank 310, a flow of untreated water 414 may enter the tank 410 via the inlet 404 located at the bottom 406 of the tank 410. As such, the tank 410 may be arranged in an “upflow” configuration, although the tank 410 may also be arranged in any other configuration. A pump or other devices (not shown) may facilitate the passage of untreated water through the tank 410 and the iron media bed 412. Once the untreated water passes through the iron media bed 412, a treated water may be provided. The treated water may exit the tank 410 via the outlet 408 located at the top of the tank 410.

Referring to FIG. 5, the disinfectant removal system 500 may include a housing 502. In some instances, the tank 510 may be disposed within the housing. In other instances, the housing 502 may be omitted. In some instances, as shown in FIG. 5, a flow of untreated water 516 may instead enter the tank 510 through an inlet 504 located at a top side 506 of the tank 510 before passing through the iron media bed 512 for treatment, generating a treated water 518. The treated water 518 may then exit the tank 510 through an outlet 508, which is also positioned at the top side 506 of the tank 510. In some such instances, a water channel 514 may be provided between one or more sections of the iron media bed 512, such that treated water is joined prior to exiting the tank 510. In some embodiments, as shown in FIG. 5, the iron media bed 512 may be provided with a first section 513a and a second section 513b.

The tank 410, 510 may, in various instances, be provided in the form of a housing (e.g., the housings 402, 502), a filtration cartridge, or retaining apparatus for the iron media bed 412, 512. In some cases, the iron media bed 412, 512 may include a binder and form a mixed matrix disposed in the housing, the filtration cartridge, or the retaining apparatus. In some instances, the housing, the filtration cartridge, or the retaining apparatus may be substantially the same as or similar to housings, filtration cartridges, and retaining apparatuses traditionally used for non-iron media beds, such as activated carbon. It is to be understood that the tanks 410, 510 may also be provided in a variety of other shapes and forms besides those described herein.

For example, referring to FIG. 6, a housing or a retaining apparatus 650 may take the form of a body 652 coupled to a screen filter 654. The retaining apparatus 650 may be designed to retain a filter media, such as a zero-valent iron filter media (not depicted in FIG. 6). The body 652 may be provided in the form of a substantially hollow cylinder, although the body 652 may also be provided in other shapes (e.g., cube, rectangular prism, cuboid, pyramid, parallelepiped, and trapezoidal prism shapes). The body 652 may include a top end 656 positioned opposite a bottom end 658, as well as a surface 660 that is substantially formed of the screen filter 654. As such, the surface 660 may feature porosity, orifices, semi-permeable membranes, or other features that provide the surface 660 with a mesh or mesh-like structure. As shown, an interior volume 662 of the body 652 may include a packed iron media bed (not depicted in FIG. 6), wherein the packed iron media bed is entirely comprised of or is coated with iron particles.

The top end 656 of the retaining apparatus 650 may be open and may include an aperture 664. Water from the disinfectant removal system may thereby enter the retaining apparatus 650 through the aperture 664 to access the iron media bed disposed within the interior volume 662. The iron media bed may be disposed at the bottom end 658 of the retaining apparatus 650, and the bottom end 658 may be sealed by an end cap 666. In some cases, the end cap 666 may have an aperture (not shown) to allow for fluid communication between the iron media bed and an inlet or outlet conduit coupled to the retaining apparatus 650 (not depicted in FIG. 6). In various cases, the retaining apparatus 650 may include a retaining element (not shown) that is designed to help keep the iron media within the retaining apparatus 650. For example, the aperture 664 may be partially covered and sealed by a second end cap that is designed to help retain the iron media in the retaining apparatus 650. As an additional example, a porous barrier may be positioned within the interior volume 662 and between the top end 656 and the bottom end 658, thereby separating the iron media from the aperture 664. As a further example, the retaining apparatus 650 may include a magnet (such as a magnet 712 of FIG. 7A) that exerts a magnetic force on the iron media, thereby helping retain the iron media within the retaining apparatus 650.

In some instances, the screen filter 654 may include orifices that may form a mesh structure, wherein the orifices may be somewhat or substantially smaller than the average diameter of the iron particles comprising the iron media bed disposed within the interior volume 662. In certain instances, the body 652 may be designed to provide structural reinforcement to the retaining apparatus 650, in particular the screen filter 654. In other instances, the retaining apparatus 650 may not include a body 652 that is separate from and contiguous with the screen filter 654.

In various instances, a volume of iron media may completely or substantially fill the interior volume 662 of the retaining apparatus 650. In other instances, to provide space for water flow and/or expansion of the iron media during a washing step of the regeneration process, the retaining apparatus 650 may include empty space above the volume of iron media (e.g., when the volume of iron media is placed proximate or adjacent to the bottom end 658). For example, in some instances, the iron media may comprise no more than about 80% of the interior volume 662 of the retaining apparatus 650. In other instances, the iron media may comprise no more than about 75%, or no more than about 70%, or no more than about 60%, or no more than about 50%, or no more than about 40%, or no more than about 30% of the interior volume 662 of the retaining apparatus 650. In other instances, the iron media may comprise at least about 1%, or at least about 5%, or at least about 10%, or at least about 20%, or at least about 25%, or at least about 35%, or at least about 45% of the interior volume 662 of the retaining apparatus 650. As an additional example, the iron media may instead comprise no more than 80% of the total volume of the retaining apparatus 650. In some such instances, the iron media may comprise no more than 75%, or no more than 70%, or no more than 60%, or no more than 50%, or no more than 40%, or no more than 30% of the interior volume 662 of the retaining apparatus 650. In other instances, the iron media may comprise at least 1%, or at least 5%, or at least 10%, or at least 20%, or at least 25%, or at least 35%, or at least 45% of the interior volume 662 of the retaining apparatus 650. In some instances, the percentage of the interior volume 662 of the retaining apparatus 650 occupied by the iron media may fall within a range bounded by any minimum value and any maximum value as described above.

A density of the iron media bed within the retaining apparatus 650 may be selected accounting for cost, weight, efficiency, and the like. For example, an iron media bed of relatively higher density may be selected because an iron media of relatively higher density may allow for quicker treatment of the aqueous disinfectants. However, in some instances, an iron media bed of a relatively lower density may be selected because the iron media bed of a relatively higher density may also be at risk for more frequent regeneration owing to saturation of the bed with byproducts and impurities. In various instances, the iron media may be imparted with a density of about 2500 kilograms per cubic meter. In some instances, the iron media may be imparted with a density of about 1000 kilograms per cubic meter to about 8000 kilograms per cubic meter, although the density of the iron media may also be somewhat less or even greater than these values. In other instances, the iron media within the retaining apparatus 650 may be imparted with a density of at least about 1000 kilograms per cubic meter, or at least about 2000 kilograms per cubic meter, or at least about 3000 kilograms per cubic meter, or at least about 4000 kilograms per cubic meter, or at least about 5000 kilograms per cubic meter, or at least about 6000 kilograms per cubic meter, or at least about 7000 kilograms per cubic meter. In certain instances, the iron media may be imparted with a density of no more than about 7800 kilograms per cubic meter. In yet other instances, the iron media within the retaining apparatus 650 may be imparted with a density of at least 1000 kilograms per cubic meter, or at least 2000 kilograms per cubic meter, or at least 3000 kilograms per cubic meter, or at least 4000 kilograms per cubic meter, or at least 5000 kilograms per cubic meter, or at least 6000 kilograms per cubic meter, or at least 7000 kilograms per cubic meter. In certain instances, the iron media may be imparted with a density of no more than 7800 kilograms per cubic meter. In some instances, the density of the iron media within the retaining apparatus 650 may fall within a range bounded by any minimum value and any maximum value as described above.

It is to be understood that the retaining apparatus 650 is shown in FIG. 6 in an upright configuration. When the retaining apparatus 650 is used in any of the disinfectant removal systems (e.g., the disinfectant removal system 300) or tanks (e.g., the tanks 310, 410, 510) described herein, the retaining apparatus may be arranged in a different configuration from the configuration illustrated in FIG. 6.

Referring now to FIG. 7A, an iron media bed 700 comprised of iron particles 704 is provided. In some instances, the iron media bed 212, 312, 412 may be provided in the form of the iron media bed 700. In various instances, some, most, or substantially all, or all of the iron particles 704 may be zero-valent iron and thereby have an oxidation state of zero. In some instances, the iron media bed 700 may include heterogeneous impurities in the form of mono-, di-, or trivalent iron particles. In yet other instances, the iron media bed 700 may be free or substantially free of mono-, di-, or trivalent iron particles. Advantageously, the iron particles 704, which are zero-valent, may act as strong electron donors and metal absorbers, with the capability to reduce and destroy nearby disinfectant molecules. Such disinfectant molecules include, but are not limited to, chloramine, chlorine, ozone, and chlorine dioxide. The iron particles 704 may also reduce and destroy aqueous disinfectant byproducts, such as chloronitramide anion.

Referring now to FIG. 7B, a length 708 of the iron particles 704 may be defined as an average diameter of the iron particles 704 within the iron media bed 700. The average diameter of the iron particles 704 may represent a mean diameter of all of the iron particles 704. While preferably uniform, a collection of the diameters of each particle of the iron particles 704 may take the form of a distribution, such as a Gaussian distribution. In some such instances, at least about 68% of the iron particles 704 may be imparted with a diameter within one standard deviation of the average diameter. In other instances, the collection of the diameters of each particle of the iron particles 704 may take the form of a non-normal distribution, wherein greater than about 68% of the iron particles 704 may be imparted with a diameter within one standard deviation of the average diameter. In some such instances, at least about 70%, or at least about 75%, or at least about 80%, or at least about 85%, or at least about 90%, or at least about 95%, or at least about 99% of the iron particles 704 may have a diameter within one standard deviation of the average diameter of the iron media bed 700. Alternatively, at least 68%, or at least 60%, or at least 70%, or at least 75%, or at least 80%, or at least 85%, or at least 90%, or at least 95%, or at least 99% of the iron particles 704 may have a diameter within one standard deviation of the average diameter of the iron media bed 700.

In some instances, the average diameter of the iron particles may be imparted with a value of about 1 to about 50 nm. For example, the average diameter may be between about 2 and about 45 nm, or between about 5 and about 40 nm, or between about 10 and about 30 nm, or between about 15 and about 25 nm, or between about 17 and about 21 nm. In other instances, the average diameter may be between 2 and 45 nm, or between 5 and 40 nm, or between 10 and 30 nm, or between 15 and 25 nm, or between 17 and 21 nm. It is to be understood that the average diameter of the iron particles may be imparted with a value, or a range of values, smaller or larger than the ranges described herein.

In certain instances, the iron media bed 700 may be produced via methods designed to generate nanometer-sized iron particles 704. Thus, in certain instances, the average diameter of the iron particles 704 may be no more than 5 nm. In some instances, the iron particles 704 of the iron media bed 700 may be provided as spherical or ovoidal components, although the iron particles may be provided in any regular or irregular three-dimensional shape. In yet other instances, the iron media bed 700 may have a porous, skeletal structure.

The average diameter may be used to calculate an average surface area of the iron particles 704 comprising the iron media bed 700. In various instances, a high surface area of the iron particles 704 of the iron media bed 700 may advantageously promote adsorption of the disinfectant compounds onto the surface of the iron particles 704, facilitating reduction and destruction of the compounds. The average diameter may therefore be tuned to afford a high surface area-to-volume ratio. Generally, the size, volume, cross-section, and surface area of the iron particles 704 may be selected in accordance with factors such as the size of the water treatment system, the anticipated concentration of disinfectants in the untreated water, and other parameters, such as the anticipated operating temperature and/or pressure of the water treatment system, cost considerations, and the like.

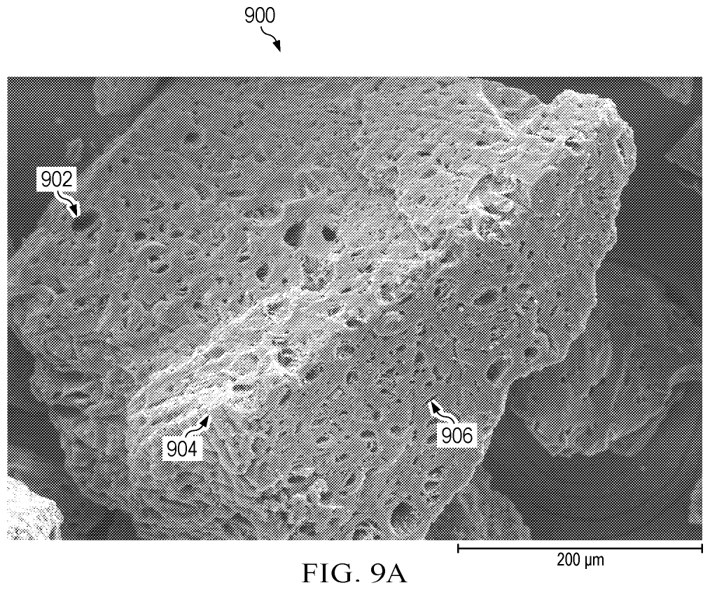

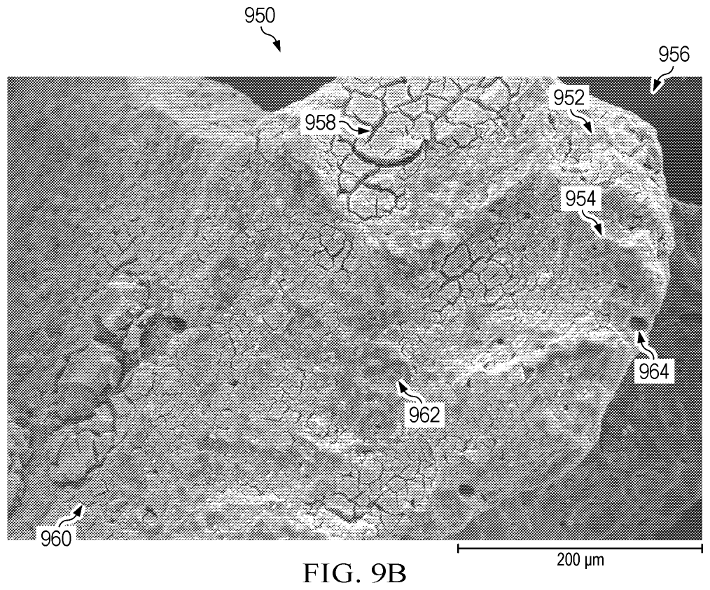

A top surface 710 of the iron media bed 700 may, in some instances, be substantially smooth without topical irregularities. In other instances, the top surface 710 may feature pores, concavities, convexities, ridges, bumps, creases, folds, and other surface textures, either as a result of wear or created during the iron media bed production process (see, e.g., FIG. 9A).

In some instances, the iron media bed 700 may be positioned proximate to or adjacent to the magnet 712. In the instance shown, the magnet 712 may be provided in the form of a cylinder forming an end 711 of the iron media bed 700. In other instances, the magnet may take the form of any other two-or three-dimensional shape (including, but not limited to, a washer-like shape, a bar, a horseshoe-like shape, a cube, a triangular prism, and a sphere) and may be placed within, above, below, adjacent to, or in close proximity to the iron media bed 700. In various instances, the magnet 712 is placed within the treatment tank retaining the iron media bed 700, although the magnet 712 may also be positioned outside of the treatment tank retaining the iron media bed 700.

Without being bound by a particular theory, owing to the ferromagnetism of the iron particles 704, the magnet 712 may advantageously promote cohesion of the particles 704 within the iron media bed 700, help prevent iron particles 704 from escaping from the iron media bed 700, and/or help prevent iron particles 704 from escaping from the apparatus in which the iron media bed 700 is disposed. In some instances, the magnet 712 may be imparted with a magnetic strength of at least about 1 mT, although the magnetic strength of the magnet 712 may be even less than this value. For example, the magnet 712 may be imparted with a magnetic strength of at least about 2 mT, or at least about 5 mT, or at least about 10 mT, or at least about 50 mT, or at least about 100 mT. As another example, the magnet 712 may be imparted with a magnetic strength of at least 1 mT, or at least 2 mT, or at least 5 mT, or at least 10 mT, or at least 50 mT, or at least 100 mT. In addition, the magnet 712 may be comprised of any ferromagnetic metal, including, but not limited to, nickel, cobalt, and neodymium. In some instances, the magnet 712 is an alloy comprising more than one of the aforementioned metals. It is to be appreciated that utilizing magnets of other strengths than those described for the magnet 712 falls within the spirit and scope of this disclosure.

In some instances, there may be more than one magnet of the magnet 712 positioned in, proximate to, or adjacent to the iron media bed 700. The number, orientation, location, size, strength, and composition of the magnet(s) 712 may be selected in accordance with properties of the iron media bed 700 and the larger disinfectant removal system.

Referring now to FIG. 8A, the iron media bed 800 may alternatively be provided in the form of an iron-coated substrate 812. In such instances, the iron particles 804 may be deposited onto a surface 814 of the substrate 812 via conventional coating methods, such as electroplating, atomic layer deposition, evaporation, etc. The deposited iron particles 804 may form an iron media layer 810. In some instances, the iron particles 804 may cover more than 50% of the surface 814 of the substrate. For example, the iron particles 804 may cover at least about 55%, or at least about 60%, or at least about 75%, or at least about 85%, or at least about 90%, or at least about 95%, or at least about 99% of the surface 814 of the substrate. In other instances, the iron particles 804 may cover at least 50%, or at least 55%, or at least 60%, or at least 75%, or at least 85%, or at least 90%, or at least 95%, or at least 99% of the surface 814 of the substrate.

Referring now to FIG. 8B, a length 808 of the iron particles 804 may be defined as an average diameter of the iron particles 804 within the iron media layer 810. The average diameter of the iron particles 804 may represent a mean diameter of all of the iron particles 804. While preferably uniform, a collection of the diameters of each particle of the iron particles 804 may take the form of a distribution, such as a Gaussian distribution. In some such instances, at least about 68% of the iron particles 804 may be imparted with a diameter within one standard deviation of the average diameter. In other instances, the collection of the diameters of each particle of the iron particles 804 may take the form of a non-normal distribution, wherein greater than about 68% of the iron particles 804 may be imparted with a diameter within one standard deviation of the average diameter. In some such instances, at least about 70%, or at least about 75%, or at least about 80%, or at least about 85%, or at least about 90%, or at least about 95%, or at least about 99% of the iron particles 804 may have a diameter within one standard deviation of the average diameter of the iron media bed 800. Alternatively, at least 68%, or at least 60%, or at least 70%, or at least 75%, or at least 80%, or at least 85%, or at least 90%, or at least 95%, or at least 99% of the iron particles 804 may have a diameter within one standard deviation of the average diameter of the iron media bed 800.

In some instances, the average diameter of the iron particles 804 may be imparted with a value of about 1 to about 50 nm. For example, the average diameter may be between about 2 and about 45 nm, or between about 5 and about 40 nm, or between about 10 and about 30 nm, or between about 15 and about 25 nm, or between about 17 and about 21 nm. In other instances, the average diameter may be between 2 and 45 nm, or between 5 and 40 nm, or between 10 and 30 nm, or between 15 and 25 nm, or between 17 and 21 nm. It is to be understood that the average diameter of the iron particles 804 may be imparted with a value, or a range of values, smaller or larger than the ranges described herein.

In certain instances, the iron media bed 800 may be produced via methods designed to generate nanometer-sized iron particles 804. Thus, in certain instances, the average diameter of the iron particles 804 may be no more than about 5 nm. In some instances, the iron particles 804 of the iron media bed 800 may be provided as spherical or ovoidal components, although the iron particles may be provided in any regular or irregular three-dimensional shape. In yet other instances, the iron media bed 800 may have a porous, skeletal structure.

The average diameter may be used to calculate an average surface area of the iron particles 804 comprising the iron media bed 800. In various instances, a high surface area of the iron particles 804 of the iron media bed 800 may advantageously promote adsorption of the disinfectant compounds onto the surface of the iron particles 804, facilitating reduction and destruction of the compounds. The average diameter may therefore be tuned to afford a high surface area-to-volume ratio. Generally, the size, volume, cross-section, and surface area of the iron particles 804 may be selected in accordance with factors such as the size of the water treatment system, the anticipated concentration of disinfectants in the untreated water, and other parameters such as the anticipated operating temperature and/or pressure of the water treatment system, cost considerations, and the like.

The composition of the substrate 812 may be selected in accordance with desired characteristics of the iron media bed 800, such as compressibility, rigidity, brittleness, flexibility, tensile strength, and the like. Examples of suitable substrates include, but are not limited to, water-resistant polymers, ceramics, metallic alloys, or non-zero-valent iron. The substrate 812 may be comprised of more than one substrate type and feature both inorganic and organic components.

The substrate 812 may additionally be provided in the form of existing filtration bed compositions, such as activated carbon. In some instances, activated carbon may be produced from vegetal sources, such as coconut, bamboo, and maize, as well as other non-vegetal sources, such as wood, coal, and petroleum pitch. In some such instances, the form of activated carbon to be implemented as a substrate may be selected in accordance with desired surface properties, including, but not limited to, pore size, graininess, thickness, and brittleness.

FIG. 9A displays an image generated using a scanning electron microscope (“SEM”) of an exemplary activated carbon substrate 900 prior to iron deposition. In the instance shown, the substrate 900 is comprised of granular activated carbon (“GAC”) under 300× magnification. The substrate 900 features a number of pores 902, ridges 904, and folds 906 across a surface of the substrate 900, although it is contemplated that other portions of the GAC substrate, both from the same or a different source, may contain greater or fewer pores 902, ridges 904, and folds 906 than the substrate 900, as well as pores 902, ridges 904, and folds 906 of a different shape, size, or texture. Turning now to FIG. 9B, an iron-coated substrate 950 may be formed upon subjecting the substrate 900 to iron media using an evaporation deposition technique. In the instance shown, the iron surface 952 contains both substantially smooth regions 954 and textured regions 956, and the textured regions 956 contain surface texture including crevices 958, cracks 960, bumps 962, and craters 964, although the surface texture may not include all these features. It is further contemplated that, provided a change in parameters such as the deposition technique used, quality of an underlying substrate, and time of deposition, the iron surface of the coated substrate 950 could contain greater or fewer crevices 958, cracks 960, bumps 962, and craters 964, as well as crevices 958, cracks 960, bumps 962, and craters 964 of a different shape, size, or texture. In some instances, a coating process used to create the iron-coated substrate 950 may be optimized in order to provide a surface that is substantially smooth or substantially textured.

Examples of applications of a zero-valent iron media bed, such as the iron media bed 212, 312, 412, 512 described with reference to FIGS. 2-5, are provided below.

### EXAMPLES

The following non-limiting examples are provided to further illustrate the present disclosure.

### Trial 1

An 8 mL bed of a zero-valent iron media imparted with an 80×325 mesh particle size was deposited into a column configured for downflow movement of an influent water stream through the iron media bed. A stainless steel, ultrafine mesh retaining screen was affixed to the column downstream of the iron media bed. The influent water met NSF/ANSI Standard 42-2023chloramine challenge parameters and was imparted with a pH of 9.21, a monochloramine concentration of 2.73 mg/L, a TDS concentration of 246 mg/L, and an iron concentration of 0.64 mg/L. The empty bed contact time (“EBCT”) for the trial was 10 seconds.

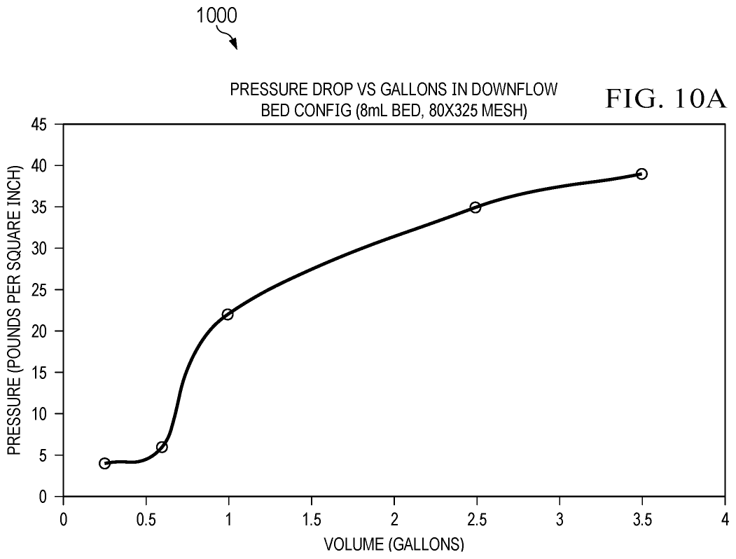

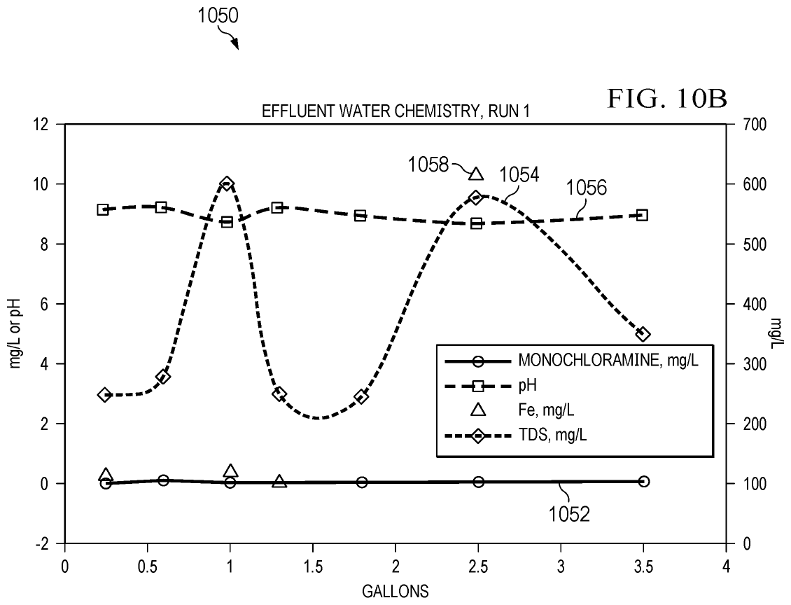

An influent water volume of about 3.79 L (2.5 gallons) was provided to the iron media. During testing, a pressure drop across the iron media bed was measured, and parameters of an effluent water were monitored. As shown in graph 1000 of FIG. 10A, an increase in the pressure drop across the bed was observed during the testing. Without being bound to a particular theory, it is believed that the pressure drop was due to accumulation of iron media particles in a neck of the column that had slipped under, around, and/or through the mesh retaining screen. Importantly, as illustrated in graph 1050 of FIG. 10B, there was no chloramine breakthrough (as indicated by the zero-point value of curve 1052). Without being bound to a particular theory, it is believed that the fluctuations in TDS values 1054 and the drop in pH values 1056 observed were due to sudden washouts of iron oxide microparticles from the column, as suggested by the non-zero value of value 1058, indicative of the concentration of iron in the effluent water.

### Trial 2

A 10 mL bed of a zero-valent iron media imparted with an 80×325 mesh particle size was deposited into a column configured for upflow movement of an influent water stream through the iron media bed. The influent water was imparted with a pH of 8.93, a monochloramine concentration of 3.52 mg/L, a TDS concentration of 253 mg/L, and an iron concentration of 0.64 mg/L. The empty bed contact time (“EBCT”) for the trial was 10 seconds. The iron media bed was further associated with a magnet positioned near one end of the bed.

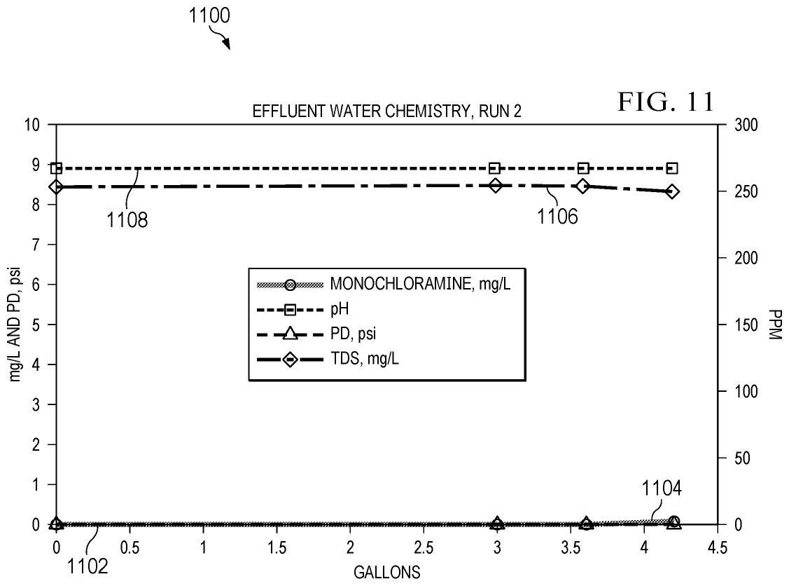

An influent water volume of about 16 L (about 4.25 gallons) was provided to the iron media during testing. During testing, an expansion of 6.3 mL in volume of the iron media bed was observed owing to the fluidization of the bed. As shown in graph 1100 of FIG. 11, and in contrast with FIGS. 10A and 10B, a pressure drop was not observed, and rather both pressure 1102 and monochloramine values 1104 remained at zero for the entirety of the trial. The TDS 1106 and pH 1108 values also remained generally constant over time. Without being bound to a particular theory, it is believed that the observed constancy of the pressure 1102, TDS 1106, and pH 1108 values was due at least in part to the presence of the magnet, which may have aided in preventing iron microparticles from leaving the filter.

### Trial 3

An additional trial conducted using an 8 mL bed of a zero-valent iron media configured for upflow movement of about 272.5 L (72 gallons) of an influent water stream through the iron media bed similarly resulted in no chloramine breakthrough. Importantly, this result suggests a substantial increase in performance of the iron media bed in chloramine destruction and removal compared with traditional catalytic carbon beds.

### Method

Turning to FIG. 12, a method 1200 for using a disinfectant removal system is provided. The method 1200 may include a step 1204 of providing a zero-valent iron media bed in a water filtration assembly. The zero-valent iron media bed may be comprised of, consist essentially of, or consist of iron particles having an oxidation state of zero. In certain cases, the iron particles are homogeneous in size, although in some instances, the zero-valent iron media bed may include a percentage of iron particles with an oxidation state of positive one, two, or three. In other instances, the iron media bed may be comprised of a substrate that may be coated with zero-valent iron particles. In some instances, the zero-valent iron media bed may be disposed in the disinfectant removal system.

The water filtration assembly may comprise additional components such as a water softener, a tank, a pump, a membrane filtration assembly, and/or sensors in the form of flow meters and pressure gauges. The membrane filtration assembly may further comprise additional filtration media such as activated or catalytic carbon for removing particulates from the untreated water.

The method 1200 may include a step 1208 of providing a first sensor to test a first concentration of aqueous disinfectants in the untreated water. The sensor may be an amperometric sensor, an automated kit, or an electrode in fluid communication with the untreated water. The sensor may also be in electrical communication with a controller such that upon collection of data associated with the untreated water, the controller may initiate an action by the disinfectant removal system or the water filtration assembly. In some instances, the sensor may be designed to measure the concentration of aqueous disinfectants. In some such instances, the sensor may be designed to measure the concentration of oxidizing disinfectants selected from the group consisting of chlorine, chloramine, ozone, and chlorine dioxide. For example, the sensor may be designed to measure the concentration of chloramine.

The method 1200 may include a step 1212 of passing untreated water through the zero-valent iron media bed to remove aqueous disinfectants from the water sample to produce treated water. The step 1212 may optionally include the use of a pump to propel or move the untreated water through the bed, for example, against gravity. The optional pump may be in electrical communication with the controller. The zero-valent iron bed may remove the aqueous disinfectants from the untreated water by providing a surface upon which the disinfectants may adsorb, thereby promoting electron transfer from the iron particles to the disinfectants. The disinfectants may then decompose after acceptance of the electrons (a reduction reaction) to form one or more byproducts. In some instances, the one or more byproducts may remain linked via intermolecular forces to the zero-valent iron bed.

The method 1200 may include a step 1216 of testing a second concentration of aqueous disinfectants in the treated water with a second sensor. The second sensor may be in electrical communication with the controller. In some instances, upon receiving data of the second concentration of the disinfectants from the second sensor, the controller may determine a differential between the first and the second concentrations. In other instances, the controller may determine a differential between either the first or the second concentration and a threshold concentration value. The controller may then determine a subsequent action, such as regeneration, as a result of the determined differentials (e.g., see a step 1224).

The method 1200 may include a step 1220 of returning the treated water to the remainder of the water filtration assembly. The treated water may exit the disinfectant removal system and be further processed or may be provided to, for example, home appliances for use.

The method 1200 may include the step 1224 of determining a status of the zero-valent iron media bed saturation. The controller may use, for example, a differential between the first concentration and the second concentration to determine the degree of saturation of the zero-valent iron media bed with byproducts by comparing the differential to a predetermined threshold value. Alternatively, the controller may determine the saturation status by comparing the second concentration to the predetermined threshold value. Optionally, after determining that the saturation of the zero-valent iron media bed is greater than an allowable amount, the controller may determine that regeneration of the zero-valent iron media bed is needed. In some such cases, the controller may further initiate regeneration of the zero-valent iron media bed by changing a mode of the disinfectant removal system from a service mode to a regeneration mode and flushing and/or soaking the zero-valent iron media bed with a reducing solution. In certain cases, no action is taken by the disinfectant removal system when it is determined that the zero-valent iron media bed is not saturated (i.e., when the concentration differential is below the predetermined threshold value). Alternatively, an alert may be generated when the controller determines that regeneration should be initiated in the near future.

In some instances, the steps 1208, 1216 may include positioning the sensors at an inlet or outlet of the disinfectant removal system.

The steps of the method 1200 may be initiated more than once, at predetermined time intervals, and implemented in any order.

It is to be understood that the above method may be implemented in any of the systems (e.g., the home water system 100, the water treatment system 200, the disinfectant removal system 300, 400, 500, and any variations thereof) described herein. Accordingly, the method 1200 may include fewer or more steps depending on the instance. In addition, the method 1200 may be implemented more than once, and the steps of method 1200 may be performed in any order. In some cases, one or more steps of the method 1200 may be omitted.

It is to be understood that one or more of the values (e.g., the first and second concentration, etc.) associated with the methods described herein may be measured at different time intervals or different time periods. The one or more values may be measured on demand, manually implemented, or at predetermined time periods (e.g., continuously, once a second, once a minute, once a day, once a week, once a month, etc.). Further, it is to be understood that the one or more values associated with any of the methods described herein may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition, such as a volume of water. In each instance, such measurements may be carried out by one or more measurement devices provided with the disinfectant removal systems described herein and then received and stored by the controller.

In addition, the predetermined values, thresholds, ranges, and other information described with reference to any of the methods described herein may be manually implemented or otherwise input into the system. For example, the predetermined threshold values may be manually input via the input 360 of the local controller 344 of FIG. 3, provided to the local controller 344 via a user device, or otherwise associated with and retained by the local controller 344.

It is to be understood that the disinfectant removal systems described herein may not be provided with a local controller. In such instances, a central controller or another controller may help direct operation of the disinfectant removal systems. In other instances, a central controller (e.g., the central controller 164, 264) may implement any of the operations described herein with reference to a local controller (e.g., the local controller 344). In yet other instances, a local controller (e.g., the local controller 344) may implement any of the operations described herein with reference to a central controller (e.g., the central controller 164, 264).

It is also to be understood that the method 1200 and any other methods discussed herein may be utilized with any of the residential or commercial water systems (e.g., the home water system 100 of FIG. 1 or the water treatment system 200 of FIG. 2), any of the disinfectant treatment systems (e.g., the disinfectant removal system 300 of FIG. 3) and any variations thereof, described herein.

In some instances, the above methods and processes described herein may use machine learning (ML), artificial intelligence (AI), or similar processes, to iteratively train the controller and improve the performance of the system based on one or more feedback parameters, characteristics, or similar information. For example, in some instances, ML/AI may be used to predict an optimal water testing interval or threshold value. In some instances, ML/AI may be used to provide accurate chemical testing and/or predict disinfectant concentration trends. Thus, the system may be optimized to reduce fluctuations in the frequency of aqueous compounds testing by the sensors or implement dual testing mechanisms such that testing values may be “checked.” This may reduce the likelihood of false positives and failures of the system to recognize when regeneration must take place.

It is to be further understood that the above methods and processes described herein may be designed to operate on untreated water at conditions both within and outside the ambient range. For example, an operating temperature of the water within the water treatment system undergoing treatment may be anywhere from less than the freezing temperature (0° C.) to at or above the boiling temperature (100° C.) of water. Similarly, an operating pH of the water within the water treatment system undergoing treatment may be anywhere from less than 0 to above 14. Given that some oxidizing disinfectants may no longer be stable at very high or low acidities, the pH of the water provided to the water treatment system may be between about 5 and 10 in some instances.

The present disclosure offers the following technical advantage over existing solutions: an improved water treatment system for removing oxidizing aqueous disinfectants from water, wherein the water treatment system utilizes an iron media bed for increased efficiency of disinfectant reduction, and wherein the bed is regenerable and cost-effective.

While the disclosure has been described above in connection with particular aspects and examples, the disclosure is not necessarily so limited, and that numerous other aspects, examples, uses, modifications, and departures from the aspects, examples, and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

1. A water treatment system comprising:
a treatment tank including:
an inlet in fluid communication with a source of untreated water, wherein the untreated water is imparted with a first concentration of an aqueous substance;
an outlet designed to provide a treated water from the treatment tank, wherein the treated water is imparted with a second concentration of the aqueous substance; and
a particle bed comprising zero-valent iron media disposed within the treatment tank, the particle bed designed to produce the treated water from the untreated water.

2. The water treatment system of claim 1, wherein the aqueous substance is an oxidizing disinfectant compound.

3. The water treatment system of claim 2, wherein the oxidizing disinfectant compound is selected from the group consisting of ozone, chlorine, chloramine, chlorine dioxide, and combinations thereof.

4. The water treatment system of claim 1, wherein the aqueous substance is a non-oxidizing disinfectant compound.

5. The water treatment system of claim 1, wherein the aqueous substance is selected from the group consisting of oxidizing disinfectant compounds, non-oxidizing disinfectant compounds, heavy metals, volatile organic compounds, and combinations thereof.

6. The water treatment system of claim 1, wherein the particle bed consists essentially of zero-valent iron particles.

7. The water treatment system of claim 1, wherein the particle bed comprises a substrate, and a surface of the substrate is coated with zero-valent iron particles.

8. A water treatment system comprising:
a housing;
an inlet and an outlet that are in fluid communication with an interior of the housing; and
a zero-valent iron media bed positioned within the interior of the housing, wherein the zero-valent iron media bed is designed to remove a disinfectant compound from an untreated water provided to the inlet.

9. The water treatment system of claim 8 further including:
a first sensor in fluid communication with the outlet; and
a controller in electrical communication with the first sensor,
wherein:
the untreated water is imparted with a first concentration of chloramine,
the first sensor is designed to measure a second concentration of chloramine in a treated water produced by the water treatment system and provide a measured value of the second concentration to the controller.

10. The water treatment system of claim 9 further including a second sensor in fluid communication with the inlet and in electrical communication with the controller, wherein the second sensor is designed to measure the first concentration of chloramine in the untreated water and provide a measured value of the first concentration to the controller.

11. The water treatment system of claim 9, wherein:
the water treatment system further includes a flow meter in fluid communication with the housing and in electrical communication with the controller,
the first sensor measures the second concentration of chloramine at regular intervals, whereby the regular intervals are based on a volume of water measured by the flow meter.

12. The water treatment system of claim 8, wherein the housing further includes:
a top portion;
a bottom portion; and
a surface provided in the form of a mesh that extends from the top portion to the bottom portion, wherein the top portion, the bottom portion, and the surface together define the interior of the housing, and the mesh comprises a plurality of orifices imparted with a first diameter,
wherein the iron media bed comprises a plurality of iron particles imparted with a second diameter, and
wherein the first diameter is smaller than the second diameter.

13. The water treatment system of claim 8, wherein:
the zero-valent iron media bed produces a treated water from the untreated water,
the untreated water is imparted with a first concentration of chloramine and the treated water is imparted with a second concentration of chloramine,
the second concentration of chloramine is at least about 90% less than the first concentration of chloramine.

14. The water treatment system of claim 8, wherein:
the zero-valent iron media bed produces a treated water from the untreated water,
the treated water is imparted with a chloramine concentration of no more than about 4 ppm.

15. A method for reducing a concentration of a disinfectant in a water stream, the method comprising:
providing a zero-valent iron media bed in a water treatment system; and
passing untreated water through the zero-valent iron media bed to remove the disinfectant from the untreated water, thereby producing a treated water.

16. The method of claim 15, further comprising:
providing a first sensor in fluid communication with a source of the untreated water; and
providing a second sensor in fluid communication with a source of the treated water;
measuring a first concentration of the aqueous disinfectant in the untreated water;
measuring a second concentration of the aqueous disinfectant in the treated water; and
determining a media bed saturation status, wherein the media bed saturation status is a differential between the first concentration of the aqueous disinfectant and the second concentration of the aqueous disinfectant.

17. The method of claim 16, wherein the second concentration is at least about 95% less than the first concentration when the zero-valent iron media bed is unsaturated.

18. The method of claim 16 further including:
washing the zero-valent iron media with a reducing solution; and
reducing the saturation of the zero-valent iron media bed.

19. The method of claim 16, wherein the first sensor and the second sensor are in electrical communication with a controller and wherein the controller determines a differential between the first concentration and the second concentration and compares the differential with a predetermined threshold value.

20. The method of claim 19, further comprising:
taking no action if a concentration differential is below the predetermined threshold value;
generating an alert if the concentration differential is near the predetermined threshold value; and
initiating regeneration of the zero-valent iron media bed if the concentration differential is at or above the predetermined threshold value.
